(19) United States
(12) Patent Application Publication
(10) Pub. No.: US 2025/0379978 A1
(43) Pub. Date: Dec. 11, 2025

(54) NEURAL NETWORK CODEC WITH HYBRID ENTROPY MODEL AND FLEXIBLE QUANTIZATION

(71) Applicant: Microsoft Technology Licensing, LLC, Redmond, WA (US)

(72) Inventors: Jiahao LI, Beijing (CN); Bin LI, Beijing (CN); Yan LU, Beijing (CN)

(73) Assignee: Microsoft Technology Licensing, LLC, Redmond, WA (US)

(21) Appl. No.: 18/875,595

(22) PCT Filed: Jun. 21, 2022
(86) PCT No.: PCT/CN2022/100259

§ 371 Date: Dec. 16, 2024

(51) Int. Cl. H04N 19/124; H04N 19/147; H04N 19/192; H04N 19/567; H04N 19/91

(52) U.S. Cl. CPC H04N 19/124; H04N 19/147; H04N 19/192; H04N 19/567; H04N 19/91

(57) ABSTRACT

Innovations in systems, methods, and software for features of a neural image or video codec are described herein. For example, a neural video encoder can receive a current video frame, encode the current video frame to produce encoded data, and output the encoded data as part of a bitstream. As part of the encoding, the encoder can determine a current latent representation for the current video frame, and encode the current latent representation using an entropy model network that includes one or more convolutional layers. As part of the encoding the current latent representation, the encoder can estimate statistical characteristics of a quantized version of the current latent representation based at least in part on a previous latent representation for a previous video frame, and entropy code the quantized version of the current latent representation based at least in part on the estimated statistical characteristics.

### BACKGROUND

Engineers use compression (also called source coding or source encoding) to reduce the bit rate of digital video. Compression decreases the cost of storing and transmitting video information by converting the information into a lower bit rate form. Decompression (also called decoding) reconstructs a version of the original information from the compressed form. A “codec” is an encoder/decoder system.

Over the past several decades, various video codec standards have been adopted, including the ITU-T H.261, H.262 (MPEG-2 or ISO/IEC 13818-2), H.263, H.264 (MPEG-4 AVC or ISO/IEC 14496-10), H.265/HEVC, H.266/VVC (ISO/IEC 23090-3 or MPEG-I Part 3) standards, the MPEG-1 (ISO/IEC 11172-2) and MPEG-4 Visual (ISO/IEC 14496-2) standards, and the SMPTE 421M (VC-1) standard. Such a video codec standard typically defines options for the syntax of an encoded video bitstream, detailing parameters in the bitstream when particular features are used in encoding and decoding. In many cases, a video codec standard also provides details about the decoding operations a video decoder should perform to achieve conforming results in decoding. Aside from codec standards, various proprietary codec formats define other options for the syntax of an encoded video bitstream and corresponding decoding operations.

More recently, some codecs use neural networks and other machine learning methods for data compression. For example, a neural image codec has been developed to compress/decompress images using an entropy model neural network (or “entropy model network,” or simply “entropy model”), which is designed to predict the probability distribution of a quantized latent representation of the images. Based on similar concepts, a neural video codec has been developed to use the entropy model to compress/decompress video frames. Despite the recent success of neural video codecs compared to conventional video compression/decompression technologies, room for improvement exists for increasing the compression quality and/or efficiency.

### SUMMARY

In summary, innovations in efficient and high-quality codec technologies are described herein. Some of the innovations described herein use an improved entropy model for a neural codec, which can efficiently exploit both spatial and temporal dependencies among video frames. Other innovations described herein provide an approach to flexible quantization in a neural codec. As described more fully below, innovations described herein include, but are not limited to, the following: incorporating a previous latent representation of a previous video frame (“latent prior”) into the entropy model to exploit the correlation among latent representations; incorporating cross-channel, cross-region prediction (“dual spatial prior”) into the entropy model to exploit spatial redundancy in a parallel-friendly manner; incorporating a flexible quantization mechanism supporting multiple rates in a single neural codec system and improving rate-distortion (“RD”) performance by dynamic bit allocation. The innovations described herein can be implemented in neural video codecs and, in some cases, neural image codecs. The innovations described herein can be implemented for future codec standards or formats.

According to one aspect of the innovations described herein, a neural video encoder can receive a current video frame, encode the current video frame to produce encoded data, and output the encoded data as part of a bitstream. As part of the encoding, the encoder can determine a current latent representation for the current video frame, and encode the current latent representation using an entropy model network that includes one or more convolutional layers. As part of the encoding the current latent representation using the entropy model network, the encoder can estimate statistical characteristics of a quantized version of the current latent representation based at least in part on a previous latent representation for a previous video frame, and entropy code the quantized version of the current latent representation based at least in part on the estimated statistical characteristics. In some cases, using the previous latent representation as an input to the entropy model network helps exploit temporal redundancy to improve RD performance of the neural video encoder.

A corresponding neural video decoder can receive encoded data as part of a bitstream, decode the encoded data to reconstruct a current video frame, and output the reconstructed current video frame. As part of the decoding, the decoder can reconstruct a current latent representation for the current video frame using an entropy model network that includes one or more convolutional layers. As part of the reconstructing the current latent representation, the decoder can estimate statistical characteristics of a quantized version of the current latent representation based at least in part on a previous latent representation for a previous video frame, and entropy decode the quantized version of the current latent representation based at least in part on the estimated statistical characteristics.

According to another aspect of the innovations described herein, a neural image encoder or neural video encoder can receive a current frame, encode the current frame to produce encoded data, and output the encoded data as part of a bitstream. As part of the encoding, the encoder can determine a current latent representation for the current frame, and encode the current latent representation using an entropy model network that includes one or more convolutional layers. Elements of the current latent representation can be logically organized along a channel dimension and two spatial dimensions. As part of the encoding the current latent representation, the encoder can split the elements of the current latent representation into multiple sets of elements in different channel sets along the channel dimension and different spatial position sets along the two spatial dimensions, where each of the multiple sets of elements has a different combination of one of the different channel sets and one of the different spatial position sets. The encoder can then estimate statistical characteristics of quantized versions of the multiple sets of elements, respectively, including, based at least in part on the quantized version of a first set of elements among the multiple sets of elements, estimating the statistical characteristics of the quantized version of a second set of elements among the multiple sets of elements. Additionally, the encoder can entropy code the quantized versions of the multiple sets of elements, respectively, based at least in part on the estimated statistical characteristics. In some cases, using cross-set estimation in the entropy model network helps exploit spatial redundancy (and potentially channel redundancy) to improve RD performance of the neural encoder.

A corresponding neural image decoder or neural video decoder can receive encoded data as part of a bitstream, decode the encoded data to reconstruct a current frame, and output the reconstructed current frame. As part of the decoding, the decoder can reconstruct a current latent representation for the current frame using an entropy model network that includes one or more convolutional layers. Elements of the current latent representation can be logically organized along a channel dimension and two spatial dimensions. The elements of the current latent representation have been split into multiple sets of elements in different channel sets along the channel dimension and different spatial position sets along the two spatial dimensions. Each of the multiple sets of elements has a different combination of one of the different channel sets and one of the different spatial position sets. As part of reconstructing the current latent representation, the decoder can estimate statistical characteristics of quantized versions of the multiple sets of elements, respectively, including, based at least in part on the quantized version of a first set of elements among the multiple sets of elements, estimating statistical characteristics of the quantized version of a second set of elements among the multiple sets of elements. Additionally, the decoder can entropy decode the quantized versions of the multiple sets of elements, respectively, based at least in part on the estimated statistical characteristics.

According to another aspect of the innovations described herein, a neural image encoder or neural video encoder can receive a current frame, encode the current frame to produce encoded data, and output the encoded data as part of a bitstream. As part of the encoding, the encoder can determine a current latent representation for the current frame. Elements of the current latent representation are logically organized along a channel dimension and two spatial dimensions. As part of the encoding, the encoder can quantize the current latent representation in multiple stages using different quantization step (“QS”) values in the multiple stages, respectively, thereby producing a quantized version of the current latent representation. Additionally, the encoder can entropy code the quantized version of the current latent representation. In some cases, using multiple stages of quantization helps provide flexibility to use a neural encoder across a range of QS values for different levels of quality and bitrate.

A corresponding neural image decoder or neural video decoder can receive encoded data as part of a bitstream, decode the encoded data to reconstruct a current frame, and output the reconstructed current frame. As part of the decoding, the decoder can reconstruct a current latent representation for the current frame. Elements of the current latent representation are logically organized along a channel dimension and two spatial dimensions. As part of reconstructing the current latent representation, the decoder can entropy decode a quantized version of the current latent representation, and inverse quantize the quantized version of the current latent representation in multiple stages using different QS values in the multiple stages, respectively.

The innovations can be implemented as part of a method, as part of a computer system configured to perform operations for the method, or as part of one or more computer-readable media storing computer-executable instructions for causing a computer system to perform the operations for the method. The various innovations can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram illustrating an example computer system in which some described embodiments can be implemented.

FIGS. 2a and 2b are diagrams illustrating example network environments in which some described embodiments can be implemented.

FIG. 3 is a diagram illustrating an example neural video encoder in conjunction with which some described embodiments can be implemented, as well as an example neural video decoder in conjunction with which some described embodiments can be implemented.

FIG. 4 is a diagram illustrating an example entropy model network, as well as splitting, quantization, inverse quantization, and concatenation operations, for a neural codec in conjunction with which some described embodiments can be implemented.

FIG. 5A is a diagram illustrating features of an example entropy model network that accepts a previous latent representation as an input.

FIG. 5B is a diagram illustrating features of processing a hyper prior for a current latent representation, for an example entropy model network.

FIG. 6 is a diagram illustrating features of multi-stage quantization and corresponding inverse quantization in a neural codec system in conjunction with which some described embodiments can be implemented.

FIG. 7 is a set of screen shots illustrating features of flexible quantization in a neural codec system.

FIGS. 8A and 8B are diagrams illustrating example network structures for a contextual encoder and contextual decoder, respectively, for motion vector information in an example neural video codec system.

FIGS. 9A and 9B are diagrams illustrating example network structures for a contextual encoder and contextual decoder, respectively, for sample value information in an example neural video codec system.

FIGS. 10A and 10B are diagrams illustrating example network structures for a frame generator and residual block with attention, respectively, in an example neural video codec system.

FIG. 11 is a diagram illustrating an example network structure for an entropy model network with a previous latent representation as input and with cross-set estimation in an example neural video codec system.

FIG. 12 is a diagram illustrating an example network structure for a temporal content encoder.

FIGS. 13A and 13B are diagrams illustrating example network structures for a hyper prior encoder and hyper prior decoder, respectively, for a current latent representation in an example neural video codec system.

FIGS. 14A and 14B are diagrams illustrating example network structures for a contextual encoder and contextual decoder, respectively, for a latent representation in an example neural image codec system.

FIGS. 15A and 15B are flowcharts illustrating generalized techniques for encoding and decoding, respectively, implementing one or more of the innovations described herein.

FIGS. 16A and 16B are flowcharts illustrating generalized techniques for determining and reconstructing, respectively, a current latent representation in some example embodiments.

FIGS. 17A and 17B are flowcharts illustrating generalized techniques for using a previous latent representation as an input to an entropy model network during encoding and decoding, respectively, in some example embodiments.

FIGS. 18A and 18B are flowcharts illustrating generalized techniques for using cross-set estimation in an entropy model network during encoding and decoding, respectively, in some example embodiments.

FIGS. 19A and 19B are flowcharts illustrating generalized techniques for multiple-stage quantization and inverse quantization, respectively, in some example embodiments.

### DETAILED DESCRIPTION

The detailed description presents innovations in efficient and high-quality codec technologies using an improved entropy model, which can efficiently exploit both spatial and temporal dependencies among frames, and using flexible quantization. As described more fully below, innovations described herein include, but are not limited to, the following: incorporating a latent prior (e.g., a previous latent representation of sample value information or motion vector information) into the entropy model to exploit the correlation among latent representations and thereby improve RD performance of a neural codec system; incorporating a dual spatial prior (e.g., a pipeline that splits elements of a latent representation into multiple sets of elements for cross-set prediction/estimation) into the entropy model to exploit the spatial redundancy among the sets of elements in a parallel-friendly manner and thereby improve RD performance of a neural codec system; incorporating a flexible quantization mechanism to achieve multiple rates in a single neural codec system and improve the RD performance by dynamic bit allocation. The innovations described herein can be implemented for future video codec standards or formats.

In the examples described herein, identical reference numbers in different figures indicate an identical component, module, or operation. Depending on context, a given component or module may accept a different type of information as input and/or produce a different type of information as output, or be processed in a different way.

More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Different embodiments use one or more of the described innovations. Some of the innovations described herein address one or more of the problems noted in the background. Typically, a given technique/tool does not solve all such problems.

### I. Overview of Neural Video Codec

Recent years have witnessed the development of neural image codec technologies. Most neural image codec technologies focus on designing an entropy model to predict the probability distribution of a quantized latent representation of an image, e.g., by using a factorized model, a hyper prior, an auto-regressive prior, a mixture Gaussian model, a transformer-based model, etc. Benefiting from these continuously improved entropy models, the compression ratio of neural image codecs has been shown to outperform more traditional image codec technologies such as H.266 intra coding. Inspired by the success of neural image codec technologies, recently neural video codec technologies have attracted more and more attention.

Most existing work on neural video codecs can be roughly classified into three categories: residual coding-based, conditional coding-based, and 3D autoencoder-based solutions. The residual coding approach comes from the traditional hybrid video codec architecture. Specifically, when encoding a current frame, a motion-compensated prediction is first generated, and then its residual with the current frame is coded. For conditional coding-based solutions, a temporal frame or feature set for a previous frame serves as a condition for the coding of the current frame. When compared with residual coding, it has been shown that conditional coding has lower or equal entropy bound. The 3D autoencoder-based solutions are a natural extension of neural image codec technologies by expanding the input dimension. However, the 3D autoencoder-based solutions can be associated with an increased encoding delay and can significantly increase the memory cost. Generally, most of these existing works focus on how to generate a latent representation of a video frame by exploring different data flows or network structures. As for the entropy model, most of these existing methods directly use ready-made solutions (e.g., the hyper prior, the auto-regressive prior, etc.) borrowed from neural image codec technologies to code the latent representation for a current frame. Spatial-temporal correlation has not been fully explored in the design of an entropy model for neural video codec technology. As a result, the RD performance of previous neural video codec technology is limited and was shown to be only slightly better than H.265 encoding.

### II. Overview of Improved Neural Video Codec with Hybrid Entropy Model and Flexible Quantization

The technology described herein improves a neural video codec by incorporating a hybrid entropy model, which can efficiently leverage both spatial and temporal correlations between and/or within video frames. Some aspects of the technology described herein can also be used for a neural image codec.

According to one aspect of disclosed technology, a previous latent representation (also referred to as “latent prior” hereinafter) for a previous video frame is included in the entropy model. Using the latent prior can help exploit the temporal correlation of the latent representation across video frames. As described more fully below, the quantized latent representation of the previous video frame can be used to predict the distribution of the quantized latent representation for the current video frame. Via a cascaded training strategy, a propagation chain of latent representation is formed. As such, an implicit connection between the latent representation of the current video frame and that of a long-range reference frame can be established. Such a connection can help the neural codec to further exploit the temporal redundancy among the latent representations.

According to another aspect of the disclosed technology, for a neural video codec or neural image codec, a dual spatial prior feature is included in the entropy model to exploit the spatial redundancy within a frame. Most existing neural codecs rely on an “auto-regressive prior” to exploit spatial correlation. However, the auto-regressive prior is a serialized solution and follows a strict scanning order. As a result, neural codecs based on the auto-regressive prior are parallel-unfriendly and tend to have a very slow speed. In contrast, the dual spatial prior described herein is a two-step coding solution based on an improved checkerboard context model, which is much more time-efficient. Previously, He et al. presented a checkerboard context model in “Checkerboard context model for efficient learned image compression,” in Proceedings of the IEEE/CVF Conference on Computer Vision and Pattern Recognition, 14771-14780, 2021. There, all channels follow the same coding order (e.g., elements in even positions are always first coded and then used as context for coding elements in the odd positions). Such an approach cannot efficiently cope with certain video content because, sometimes, coding the even positions first has worse RD performance than coding the odd positions first. In contrast, as described more fully below, the dual spatial prior introduces a mechanism that first codes one half of a latent representation for elements in both odd and even positions, and then codes the other half of the latent representation, which can benefit from the contexts from elements in all (both odd and even) positions. Moreover, correlation across multiple channels of the latent representation can also be exploited during the two-step coding. Without bringing extra coding dependency, the dual spatial prior approach increases the scope or dimension of the spatial context and exploits the channel context. As a result, more accurate prediction on probability distribution of the quantized latent representation can be achieved.

According to yet a further aspect of the disclosure, for a neural video codec or neural image codec, the entropy model is configured to support an adaptive quantization mechanism. For a neural codec, one challenge is how to achieve smooth rate adjustment in a single model of trained neural codec. In a traditional (non-neural) codec, smooth rate adjustment can be achieved by adjusting a quantization parameter. However, conventional neural codecs lack such capability and typically use a fixed quantization step (“QS”). To achieve different rates, such a conventional neural codec needs to be retrained, which can increase the burden for model training and model storage. In contrast, the adaptive quantization mechanism powered by the improved entropy model described herein allows quantization at multi-granularity levels. For example, as described more fully below, the whole (collective) QS can be determined at three different granularities. First, a global QS value can be set by a user for a specific target rate. Then, the global QS can be multiplied by a channel-wise (or per-channel) QS value, because different channels may contain information with different importance. Then, the product of the global QS value and channel-wise QS value can be further multiplied by a spatial-channel-wise (or per-area) QS value generated by the entropy model. Such an adaptive quantization mechanism can help the neural codec to cope with various types of content and achieve precise rate adjustment at each position of the global QS. In addition, the adaptive quantization mechanism can train the entropy model to learn the QS (in particular, the spatial-channel-wise/per-area QS values), thereby leading to not only smooth rate adjustment in a single model for different global QS values, but also improvement in the RD performance. This is because, with the adaptive quantization mechanism, the entropy model can learn to allocate more bits (through spatial-channel-wise/per-area QS values) to the more important contents, which are vital for the reconstruction of the current and following video frames. This kind of content-adaptive quantization mechanism enables dynamic bit allocation to boost the final compression ratio.

### III. Example Computer Systems

FIG. 1 illustrates a generalized example of a suitable computer system (100) in which several of the described innovations may be implemented. The computer system (100) is not intended to suggest any limitation as to scope of use or functionality, as the innovations may be implemented in diverse general-purpose or special-purpose computer systems.

With reference to FIG. 1, the computer system (100) includes one or more processing units (110, 115) and memory (120, 125). The processing units (110, 115) execute computer-executable instructions. A processing unit can be a general-purpose central processing unit (“CPU”), processor in an application-specific integrated circuit (“ASIC”) or any other type of processor. In a multi-processing system, multiple processing units execute computer-executable instructions to increase processing power. For example, FIG. 1 shows a CPU (110) as well as a graphics processing unit or co-processing unit (115). The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations for a neural codec with a hybrid entropy model and/or flexible quantization, in the form of computer-executable instructions suitable for execution by the processing unit(s).

A computer system may have additional features. For example, the computer system (100) includes storage (140), one or more input devices (150), one or more output devices (160), and one or more communication connections (170). An interconnection mechanism (not shown) such as a bus, controller, or network interconnects the components of the computer system (100). Typically, operating system software (not shown) provides an operating environment for other software executing in the computer system (100), and coordinates activities of the components of the computer system (100).

The tangible storage (140) may be removable or non-removable, and includes magnetic media such as magnetic disks, magnetic tapes or cassettes, optical media such as CD-ROMs or DVDs, or any other medium which can be used to store information and which can be accessed within the computer system (100). The storage (140) stores instructions for the software (180) implementing one or more innovations for a neural codec with a hybrid entropy model and/or flexible quantization.

The input device(s) (150) may be a touch input device such as a keyboard, mouse, pen, or trackball, a voice input device, a scanning device, or another device that provides input to the computer system (100). For video, the input device(s) (150) may be a camera, video card, screen capture module, TV tuner card, or similar device that accepts video input in analog or digital form, or a CD-ROM or CD-RW that reads video input into the computer system (100). The output device(s) (160) may be a display, printer, speaker, CD-writer, or other device that provides output from the computer system (100).

The communication connection(s) (170) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computer system (100), computer-readable media include memory (120, 125), storage (140), and combinations thereof. Thus, the computer-readable media can be, for example, volatile memory, non-volatile memory, optical media, or magnetic media. As used herein, the term computer-readable media does not include transitory signals or propagating carrier waves.

The innovations can be described in the general context of computer-executable instructions, such as those included in program modules, being executed in a computer system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or computing device. In general, a computer system or computing device can be local or distributed, and can include any combination of special-purpose hardware and/or general-purpose hardware with software implementing the functionality described herein.

The disclosed methods can also be implemented using specialized computing hardware configured to perform any of the disclosed methods. For example, the disclosed methods can be implemented by an integrated circuit (e.g., an ASIC such as an ASIC digital signal processor (“DSP”), a graphics processing unit (“GPU”), or a programmable logic device (“PLD”) such as a field programmable gate array (“FPGA”)) specially designed or configured to implement any of the disclosed methods.

For the sake of presentation, the detailed description uses terms like “select” and “determine” to describe computer operations in a computer system. These terms are high-level abstractions for operations performed by a computer, and should not be confused with acts performed by a human being. The actual computer operations corresponding to these terms vary depending on implementation.

### IV. Example Network Environments

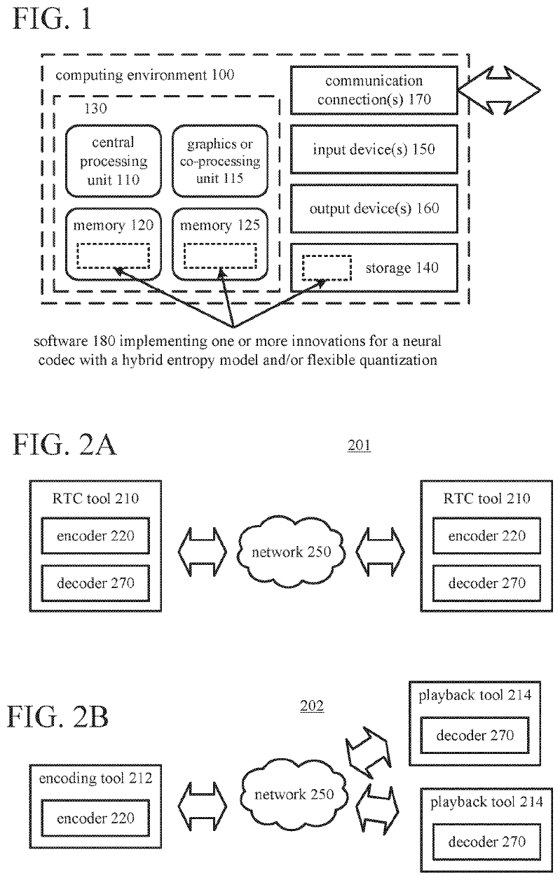

FIGS. 2A and 2B show example network environments (201, 202) that include video encoders (220) and video decoders (270). The encoders (220) and decoders (270) are connected over a network (250) using an appropriate communication protocol. The network (250) can include the Internet or another computer network.

In the network environment (201) shown in FIG. 2A, each real-time communication (“RTC”) tool (210) includes both an encoder (220) and a decoder (270) for bidirectional communication. A given encoder (220) can output encoded data as part of a bitstream, with a corresponding decoder (270) accepting the encoded data from the encoder (220). The bidirectional communication can be part of a video conference, video telephone call, or other two-party or multi-party communication scenario. Although the network environment (201) in FIG. 2A includes two real-time communication tools (210), the network environment (201) can instead include three or more real-time communication tools (210) that participate in multi-party communication

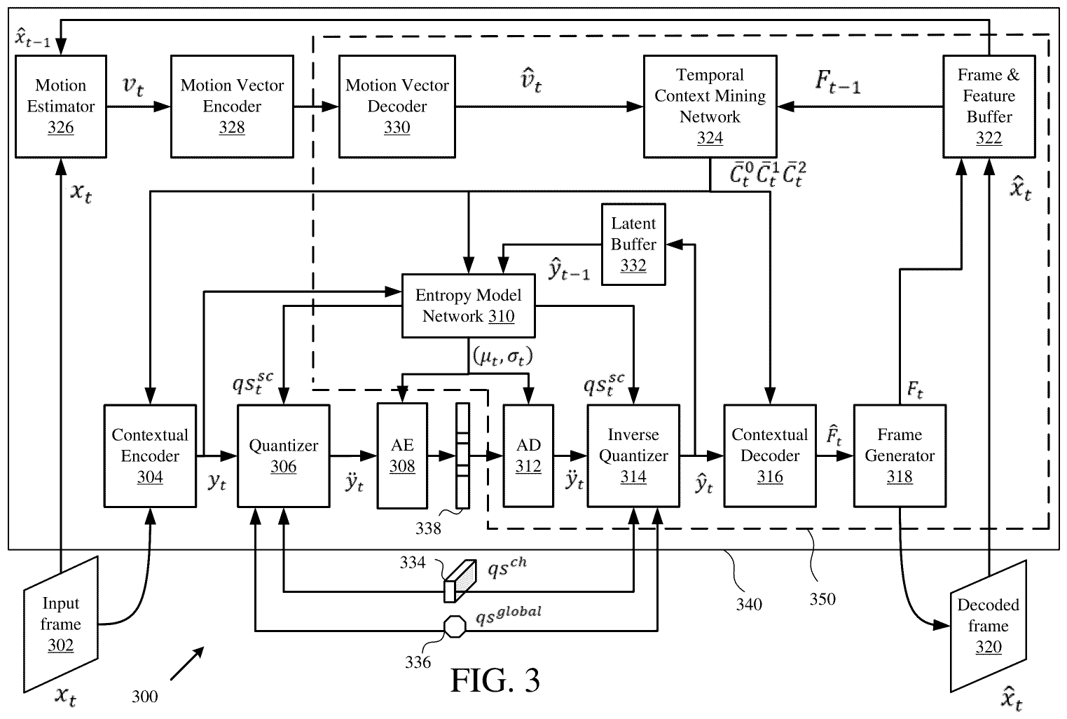

A real-time communication tool (210) manages encoding by an encoder (220) FIG. 3 shows an example encoder (340) that can be included in the real-time communication tool (210). A real-time communication tool (210) also manages decoding by a decoder (270). FIG. 3 also shows an example decoder (350) that can be included in the real-time communication tool (210).

In the network environment (202) shown in FIG. 2B, an encoding tool (212) includes an encoder (220) that encodes video for delivery to multiple playback tools (214), which include decoders (270). The unidirectional communication can be provided for a video surveillance system, web camera monitoring system, remote desktop conferencing presentation or sharing, wireless screen casting, cloud computing or gaming, or other scenario in which video is encoded and sent from one location to one or more other locations. Although the network environment (202) in FIG. 2B includes two playback tools (214), the network environment (202) can include more or fewer playback tools (214). In general, a playback tool (214) communicates with the encoding tool (212) to determine a stream of video for the playback tool (214) to receive. The playback tool (214) receives the stream, buffers the received encoded data for an appropriate period, and begins decoding and playback.

FIG. 3 shows an example encoder (340) that can be included in the encoding tool (212). The encoding tool (212) can also include server-side controller logic for managing connections with one or more playback tools (214). A playback tool (214) can include client-side controller logic for managing connections with the encoding tool (212). FIG. 3 also shows an example decoder (350) that can be included in the playback tool (214).

### V. Example Improved Neural Video Codec System

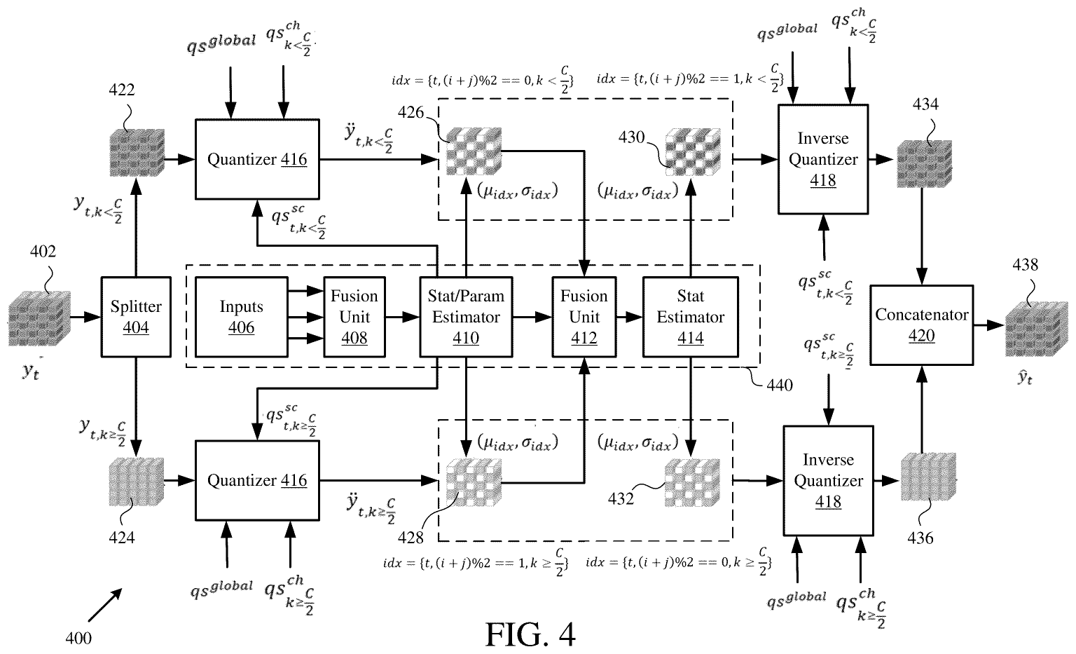

FIG. 3 shows an example neural video codec system (300) in conjunction with which some described embodiments may be implemented. The neural video codec system (300) includes a neural video encoder (340) configured to encode video frames into encoded data using a hybrid entropy model. The neural video encoder (340) can be an embodiment of the encoder (220) depicted in FIGS. 2A-2B. The neural video codec system (300) also includes a neural video decoder (350) configured to reconstruct the video frames from the encoded data using the hybrid entropy model. The neural video decoder (350) can be an embodiment of the decoder (270) depicted in FIGS. 2A-2B. As shown, the neural video encoder (340) can comprise the neural video decoder (350). In certain examples, the neural video decoder (350) can be a standalone system. For example, the neural video decoder (350) is separate when a computer system includes only a decoder. An example hybrid entropy model is further detailed in FIG. 4.

The neural video codec system (300) or portions of the neural video codec system (300), such as the neural video encoder (340) and/or the neural video decoder (350), can be implemented as part of an operating system module, as part of an application library, as part of a standalone application, or using special-purpose hardware. Overall, the neural video encoder (340) receives a sequence of source video frames from a video source (e.g., a camera, tuner card, storage media, screen capture module, or other digital video source) and produces encoded data as output to an output channel (338). The encoded data output to the output channel (338) can include content encoded using one or more of the innovations described herein. When separate, a neural video decoder (350) receives encoded data from the output channel (338) and produces reconstructed video frames (320) as output for an output destination (e.g., video display devices, storage media, etc.). The received encoded data can include content encoded using one or more of the innovations described herein. As used herein, the term “frame” generally refers to source, coded or reconstructed image data.

The neural video encoder (340) receives a current video frame (302), encodes the current video frame (302) to produce encoded data, and output the encoded data as part of a bitstream fed to the output channel (338). As part of the encoding, the neural video encoder (340) in some cases uses one or more features of the hybrid entropy model as described herein. As shown, the neural video encoder (340) also includes at least some components of a neural video decoder (350) in a reconstruction loop, including components for inverse quantization, context decoding, frame generation, buffering, temporal context mining, and motion vector decoding. The neural video decoder (350) can receive encoded data as part of a bitstream, decode the encoded data to reconstruct the current video frame, and output the reconstructed current video frame (320). As part of the decoding, the neural video decoder (350) in some cases uses one or more features of the hybrid entropy model as described herein. In FIG. 3, the current video frame (302) is denoted as xₜ, where is the frame index, and the reconstructed current video frame (320) is denoted as \hat{x}ₜ.

As described herein, the neural video encoder (340) can be configured to generate temporal context parameters associated with the current video frame, performing contextual encoding and contextual decoding for the current video frame, and reconstructing the current video frame, as described below.

### A. Example Generation of Temporal Context Parameters

Several modules, including a motion estimator (326), a motion vector (“MV”) encoder (328), a MV decoder (330), a temporal context mining network (324), and a frame and feature buffer (322), are involved in generating temporal context parameters.

The current video frame xₜ and the reconstructed previous video frame \hat{x}ₜ₋₁ (retrieved from the frame and feature buffer (322)) are fed into the motion estimator (326) to generate a set of MV values vₜ for the current video frame. The set of MV values vₜ includes values which represent or characterize a transformation from the previous video frame to the current video frame. In certain examples, the motion estimator (326) can be implemented based on a pre-trained Spynet, as described by Ranjan and Black in “Optical flow estimation using a spatial pyramid network,” in Proceedings of the IEEE conference on computer vision and pattern recognition. 4161-4170, 2017. Alternatively, the motion estimator (326) can be implemented in some other ways.

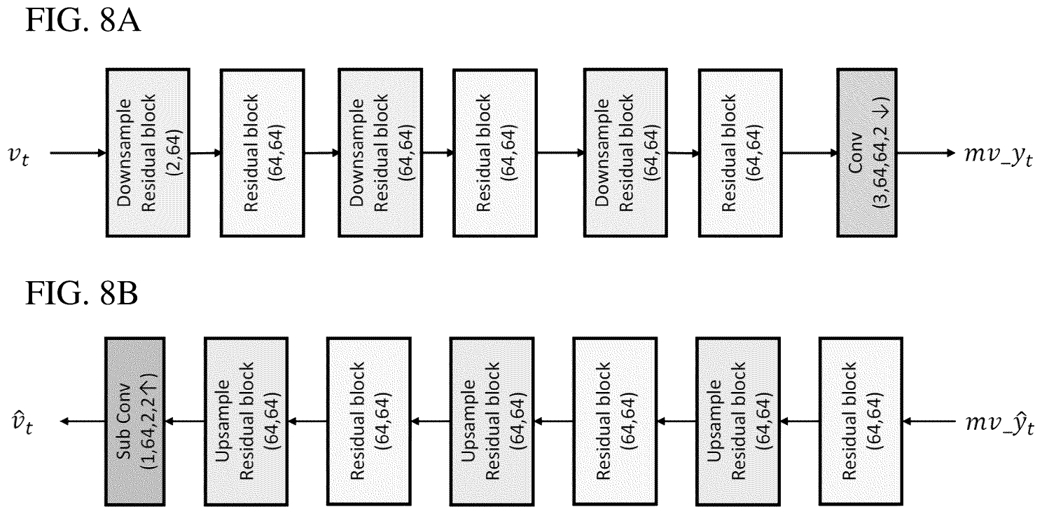

The generated set of MV values vₜ can be compressed by the MV encoder (328) and then decompressed by the MV decoder (330) to produce a reconstructed set of MV values \hat{v}ₜ. The MV encoder (328) and MV decoder (330) collectively can also be referred to as an MV codec. In certain cases, the MV encoder (328) includes one or more convolutional layers and is configured to generate a current latent MV representation from the set of MV values vₜ. Accordingly, the MV decoder (330) also includes one or more convolutional layers and is configured to reconstruct the set of MV values \hat{v}ₜ from the current latent MV representation. Although FIG. 3 does not show the internal details of the MV encoder (328) and MV decoder (330), the MV encoder (328) and MV decoder (330) can include components configured for encoding/decoding of MV information. For example, for encoding of MV information, the MV encoder (328) can include its own contextual encoder, hyper prior encoder, hyper prior decoder, entropy model network, quantizer, latent buffer (for a previous latent MV representation), inverse quantizer, context decoder, and arithmetic encoder (and, if encoding is not bypassed internally, arithmetic decoder). Similarly, when part of a separate decoder, the MV decoder (330) can include its own hyper prior decoder, entropy model network, latent buffer (for a previous latent MV representation), inverse quantizer, context decoder, and arithmetic decoder. Example network structures of a contextual encoder for the MV encoder (328) and contextual decoder for the MV decoder (330) are described further below with reference to FIGS. 8A and 8B, respectively. Alternatively, the content encoder and context decoder for MV information can be implemented using different network structures. The hyper prior encoder of the MV encoder (328) determines a highly parameterized version of the current latent MV representation from the contextual encoder, and the hyper prior decoder reconstructs a version of the current latent MV representation. Example network structures of a hyper prior encoder and hyper prior decoder for MV information are described below. Alternatively, the hyper prior encoder and hyper prior decoder for MV information can be implemented using different network structures. The entropy model network of the MV encoder (328)/MV decoder (330) can determine statistics (used for arithmetic coding and decoding of MV information) based on the reconstructed version of the current latent MV representation and a reconstructed version of the prior latent MV representation. Example network structures of an entropy model network for MV information are described below. Alternatively, the entropy model network for MV information can be implemented using a different network structure.

The reconstructed set of MV values Dt is fed to the temporal context mining network (324), which also receives input of a previous feature parameter set Fₜ₋₁ retrieved from the frame and feature buffer (322). The previous feature parameter set Fₜ₋₁ is associated with the previous video frame and is generated by a frame generator (318), as described further below.

The temporal context mining network (324) includes one or more convolutional layers and is configured to explore or capture temporal correlation existing in the video frames. An example temporal context mining network (324), including an example network structure, is described in more detail in Sheng et al., “Temporal Context Mining for Learned Video Compression,” arXiv preprint arXiv:2111.13850, 2021 (hereinafter “Sheng 2021”). Generally, the temporal context mining network (324) can be configured to generate one or more temporal context parameter sets of different scales, e.g.,

$${\overline{C}}_{t}^{0} , {\overline{C}}_{t}^{1} , {\overline{C}}_{t}^{2} ,$$

based on \hat{v}ₜ and Fₜ₋₁. The multi-scale temporal context parameter sets

$${\overline{C}}_{t}^{0} , {\overline{C}}_{t}^{1} and {\overline{C}}_{t}^{2}$$

have different spatial resolutions (e.g.,

$${\overline{C}}_{t}^{0}$$

has the same spatial resolution as

$${F}_{i - 1} , {\overline{C}}_{t}^{1} and {\overline{C}}_{t}^{2}$$

have progressively lower spatial resolutions as they are generated from progressively down-sampled versions of Fₜ₋₁, respectively), and they can be helpful in representing spatiotemporal non-uniform motion and texture information of the video frames. Although FIG. 3 shows three temporal context parameter sets

$$( {\overline{C}}_{t}^{0} , {\overline{C}}_{t}^{1} , {\overline{C}}_{t}^{2} )$$

at different scales, in some cases, the temporal context mining network (324) can be configured to generate more than three (e.g., 4, 5, etc.) or less than three (e.g., 1, 2) temporal context parameter sets.

The generated one or more temporal context parameter sets (e.g.,

$${\overline{C}}_{t}^{0} , {\overline{C}}_{t}^{1} , {\overline{C}}_{t}^{2} )$$

can be fed to other modules of neural video codec system (300), such as a contextual encoder (304), a contextual decoder (316), and an entropy model network (310), as described below.

### B. Example Contextual Encoding and Decoding

Conditioned by the multi-scale temporal context parameter sets (e.g.,

$${\overline{C}}_{t}^{0} , {\overline{C}}_{t}^{1} , {\overline{C}}_{t}^{2} ) ,$$

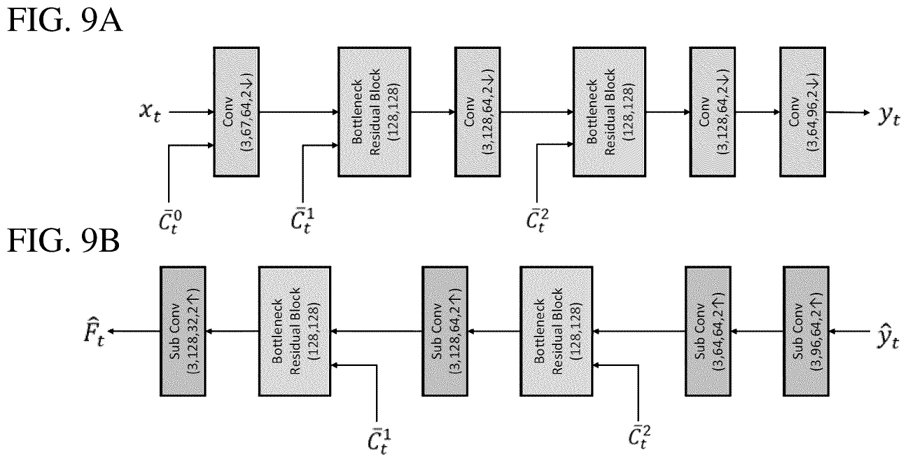

a contextual encoder (304) can be configured to generate a current latent representation yₜ for the current video frame xₜ. As described herein, elements of the current latent representation yₜ are logically organized in three dimensions, including two spatial dimensions (corresponding to height and width of the current video frame xₜ) and one channel dimension. The channel dimension, in general, organizes parameters (fundamental features or coefficients) output from a neural network layer or network structure. The number of channels depends on implementation. In general, as the number of channels increases, the complexity of a neural model network increases, and the accuracy of the neural model network also increases, at least up to a point of diminishing returns. Since the current latent representation yₜ is generated from the current video frame xₜ, the current latent representation yₜ can also be referred to as a current latent sample value (SV) representation (to distinguish it from the current latent MV representation, as described above). The contextual encoder (304) includes one or more convolutional layers. An example network structure of the contextual encoder (304) is described below with reference to FIG. 9A. Additional explanation about operations of a similar contextual encoder are described in Sheng 2021. Alternatively, the contextual encoder (304) can be implemented using a different network structure.

To achieve bitrate saving, the current latent SV representation yₜ can be quantized to a quantized version ÿₜ by a quantizer (306) before being sent to an arithmetic encoder (“AE” 308), which generates a bit stream containing the encoded data for the current latent SV representation. Similarly, elements in the quantized version of the current latent representation ÿₜ are logically organized along the two spatial dimensions and the channel dimension. During the decoding, the quantized version of the current latent representation ÿₜ is decoded from the bit steam by an arithmetic decoder (“AD” 312) and inversely quantized to a decoded (reconstructed) version of current latent representation ŷₜ by an inverse quantizer (314). In practice, since the arithmetic coding/decoding is lossless, the AD (312) can be omitted during encoding, if the quantized version of the current latent representation ÿₜ is directly conveyed to the inverse quantizer (314) within the encoder (340).

As described herein, the AE (308) and AD (312) work in conjunction with the entropy model network (310) to provide entropy encoding and entropy decoding, respectively. As described further below, the entropy model network (310) can be configured to estimate statistical characteristics of the quantized version of the current latent SV representation ÿₜ. Example statistical characteristics includes mean or average value, standard deviation, scale parameter, variance, median, etc., for a probability distribution function for the quantized version of the current latent SV representation yr. For example, for a Laplace or Gaussian distribution, the statistical characteristics can include includes a mean (μₜ) and a scale parameter (σₜ).

In addition, the entropy model network (310) can generate a plurality of per-area QS values (denoted as qs^{sc}) for different spatial areas of the current latent SV representation. The generated qs^{sc} values can be fed to the quantizer (306) and inverse quantizer (314). The quantizer (306) and inverse quantizer (314) can also receive a global QS value (336, denoted as qs^{global}) and multiple per-channel QS values (334, denoted as qs^{ch}) for different channels. Based on qs^{global}, qs^{ch} and qs^{sc}, the quantizer (306) and inverse quantizer (314) can perform multi-granularity quantization and inverse quantization, respectively, as described more fully below.

Also conditioned on the temporal context parameter sets (e.g.,

$${\overline{C}}_{t}^{0} , {\overline{C}}_{t}^{1} , {\overline{C}}_{t}^{2} ) ,$$

a contextual decoder (316) is configured to decode an estimated current feature parameter set \hat{F}ₜ from ýₜ. Like the contextual encoder (304), the contextual decoder (316) includes one or more convolutional layers. An example network structure of the contextual decoder is described below with reference to FIG. 9B. Additional explanation about operations of a similar contextual decoder are described in Sheng 2021. Alternatively, the contextual decoder (316) can be implemented using a different network structure.

In this encoding/decoding process, accurate estimation of the statistical characteristics of ÿₜ by the entropy model network (310) is vital for bitrate reduction. To this end, a hybrid entropy model is used to efficiently capture both spatial and temporal dependencies between video frames. In addition, the hybrid entropy model is configured to support multi-granularity quantization and inverse quantization in a single model. An example hybrid entropy model is described more fully below with reference to FIG. 4.

### C. Example Reconstruction of Current Video Frame

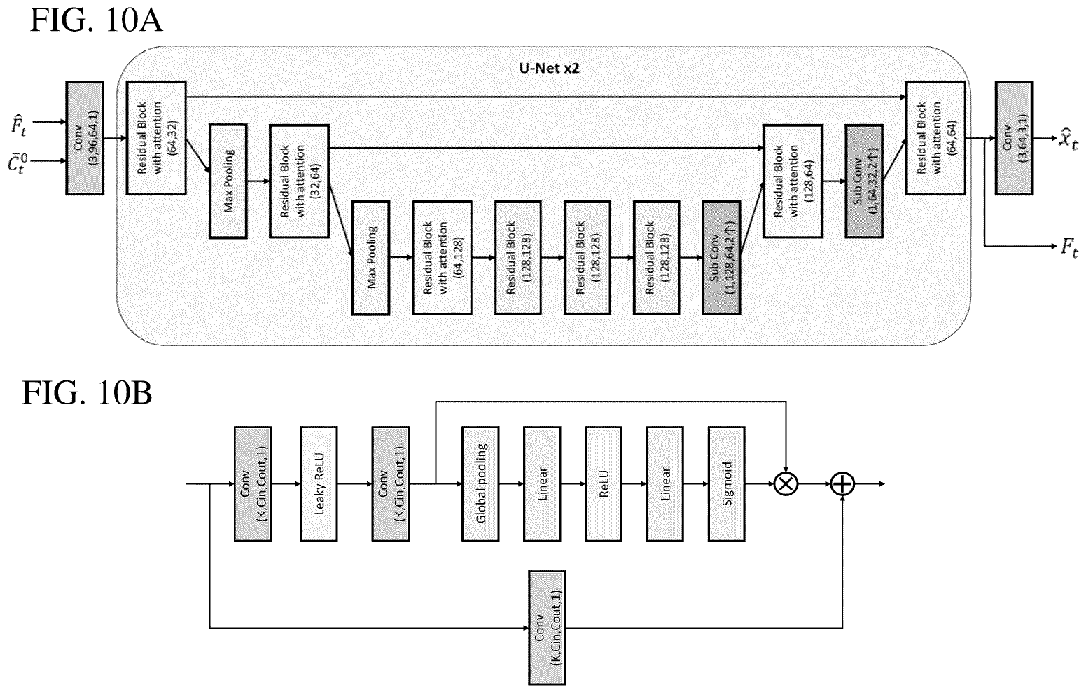

As shown in FIG. 3, a frame generator (318) is configured to generate the reconstructed current video frame \hat{x}ₜ (320) from the estimated current feature parameter set \hat{F}ₜ. In general, [symbol] represents a reconstructed version of something. For example, in FIG. 3, \hat{F}ₜ represents the reconstructed feature parameter set from the contextual decoder (316). The reconstructed video frame \hat{x}t (320) can be stored in the frame and feature buffer (322), which is analogous to a decoder picture buffer (“DPB”), and used by the motion estimator (326) to produce a set of MV values for a subsequent video frame. Additionally, the frame generator (318) also produces the current feature parameter set Fₜ. The current feature parameter set Fₜ can also be stored in the frame and feature buffer (322) and used by the temporal context mining network (324) to generate the temporal context parameter sets for a subsequent video frame. In certain cases, the frame generator (318) includes one or more convolutional layers. An example network structure of the frame generator (318) is described further below with reference to FIG. 10A. Alternatively, the frame generator (318) can be implemented using a different network structure.

### D. Example Variations of Neural Video Codec System

Depending on implementation and the type of compression/decompression desired, modules of the neural video codec system (300) can be added, omitted, split into multiple modules, combined with other modules, and/or replaced with like modules. The relationships shown between modules within the neural video encoder (340) and the neural video decoder (350) indicate general flows of information in the neural video encoder (340) and the neural video decoder (350), respectively; other relationships are not shown for the sake of simplicity. In general, a given module of the neural video codec system (300) can be implemented by software executable on a CPU, by software controlling special-purpose hardware (e.g., graphics hardware for video acceleration), or by special-purpose hardware (e.g., in an ASIC).

### VI. Example Hybrid Entropy Model

As described above, both AE (308) and AD (312) work in conjunction with the entropy model network (310) to provide entropy encoding and entropy decoding, respectively. To that end, both entropy coding and entropy decoding utilize the probability mass function (“PMF”) of the quantized version of the current latent SV representation ÿₜ. Since the true PMF of ÿₜ, or p(ÿₜ), is unknown, the entropy model network (310) approximates the true PMF p(ÿₜ) with an estimated PMF q(ÿₜ). The cross-entropy E_{ÿ}_{ₜ₋ₚ}[−log₂q(\ddot{v}ₜ)] captures the average number of bits used by the arithmetic coding without considering the negligible overhead. In certain examples, the quantized version of the current latent SV representation ÿₜ can be considered to follow the Laplace or Gaussian distribution.

FIG. 4 depicts a hybrid entropy model network (440) which can accurately estimate the statistical characteristics of ÿₜ to reduce the cross-entropy. Specifically, the hybrid entropy model network (440) incorporates a latent prior as a model input to exploit the temporal correlation of the latent representation across video frames. In FIG. 4, the hybrid entropy model network (440) also incorporates a dual spatial prior feature to exploit the spatial redundancy within a video frame, but alternatively a hybrid entropy model network can be implemented without the dual spatial prior feature. Additionally, in FIG. 4, the hybrid entropy model network (440) is configured to support an adaptive quantization mechanism that allows quantization at multi-granularity levels, but alternatively a hybrid entropy model network can be implemented without the adaptive quantization mechanism.

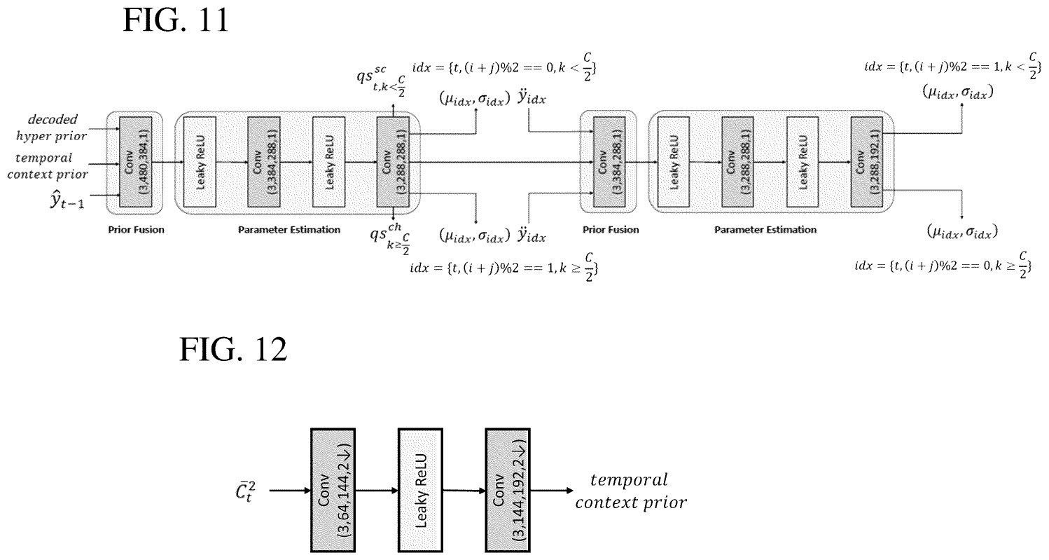

In the depicted example, the hybrid entropy model network (440) has an input unit (406), a first fusion unit (408), a first statistics/parameters estimator (410), a second fusion unit (412), and a second statistics estimator (414). Each of the first statistics/parameters estimator (410) and the second statistics estimator (414) can include one or more convolutional layers. An example network structure of the hybrid entropy model network (440) is depicted in FIG. 11 and described further below. Alternatively, the hybrid entropy model network (440) can be implemented using a different network structure.

### A. Latent Prior

To improve the estimation of statistics by the entropy model network, temporal correlation of the latent representation across video frames can be exploited. For MV encoding/decoding, the latent prior can be the previous latent MV representation. For SV encoding/decoding, the latent prior can be the previous latent SV representation. With reference to FIG. 4, as described above, elements in ÿₜ are logically organized in three dimensions including one channel dimension and two spatial dimensions. Denote ÿ_{t,i,j,k} (where i, j, and k are the height, width, and channel indexes, respectively) as an element in ÿₜ. Theoretically, each ÿ_{t,i,j,k} may be correlated to a corresponding element ŷ_{t-1,i,j,k} in the decoded latent representation for the previous video frame ŷₜ₋₁. Also, each ÿ_{t,i,j,k} may be correlated to elements of corresponding spatial locations in any of the temporal context parameter sets (e.g.,

$${\overline{C}}_{t}^{0} , {\overline{C}}_{t}^{1} , {\overline{C}}_{t}^{2} ) ,$$

which are determined based in part on the previous feature parameter set Fₜ₋₁ associated with the previous video frame and based in part on the set of reconstructed MV values \hat{v}ₜ for the current video frame. Due to large space requirement, a traditional codec is unable to explicitly exploit such correlations, and thus can only use simple handcrafted rules to use context from a few neighbor positions. By contrast, the deep learning neural network architecture enables the capability of automatically mining the correlation in a large space. For example, as shown in FIG. 4, the hybrid entropy model network (440) can receive manifold inputs via the input unit (406). As a result, the hybrid entropy model network (440) can extract complementary information from the rich high-dimensional inputs.

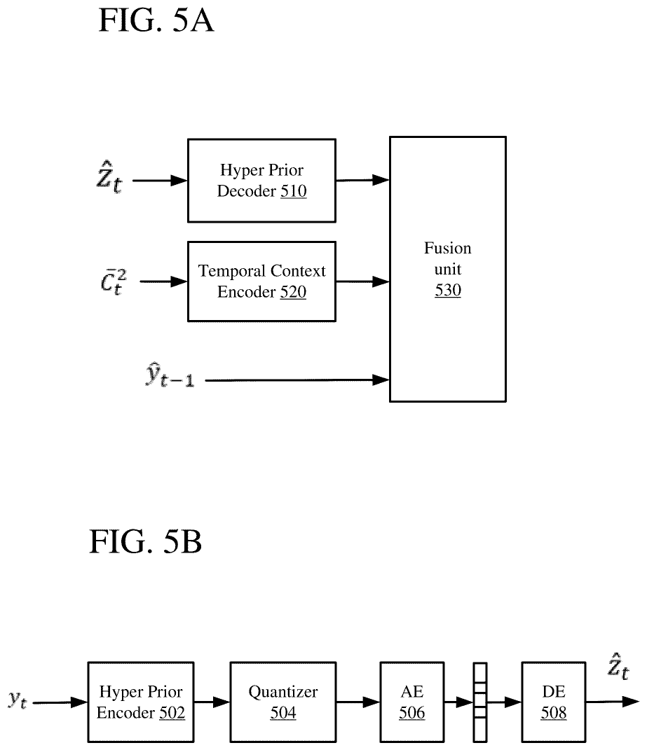

FIG. 5A shows example inputs to the hybrid entropy model network (440) for estimating statistical characteristics of ÿₜ. The fusion unit (530) depicted in FIG. 5 can be the fusion unit (408) of FIG. 4. As shown, the hybrid entropy model network can receive three different inputs: hyper prior parameters \hat{z}ₜ associated with the latent SV representation of the current video frame, one temporal context parameter set

$${\overline{C}}_{t}^{2} ,$$

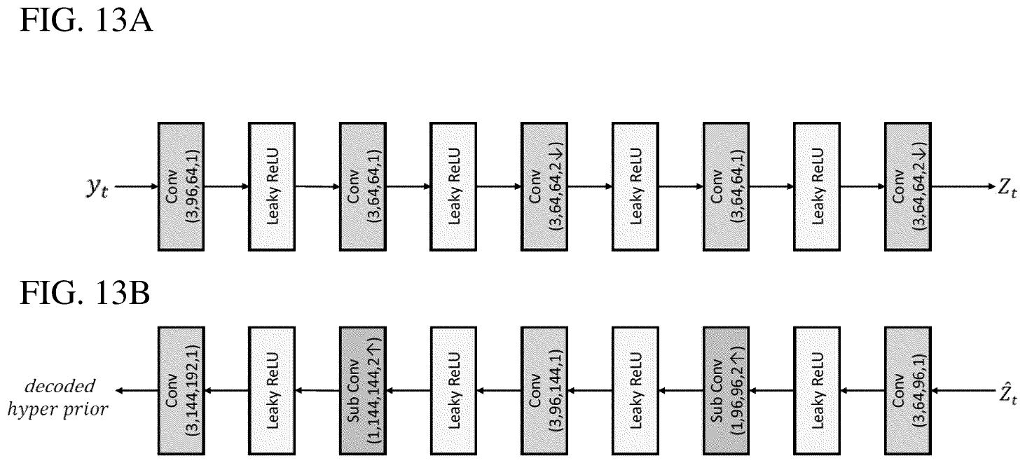

and a decoded previous latent SV representation for the previous video frame ŷₜ₋₁ (i.e., the latent prior). Before being fused by the fusion unit (530), the hyper prior information 2; is first decoded by a hyper prior decoder (510) to generate decoded hyper prior parameters. An example network structure of the hyper prior decoder for the latent SV representation is described below with reference to FIG. 13B. Alternatively, the hyper prior decoder can be implemented using a different network structure. Additionally, before being fused by the fusion unit (530), the temporal context parameter set

$${\overline{C}}_{t}^{2}$$

is first encoded by a temporal context encoder (520) to generate a temporal context prior. The temporal context encoder (520) can include one or more convolutional layers. An example network structure of the temporal context encoder is described below with reference to FIG. 12. Alternatively, the temporal context encoder can be implemented using a different network structure. FIG. 11 shows an example network structure of the fusion unit (530) (the left “Prior Fusion” layer in FIG. 11). Alternatively, the fusion unit (530) can be implemented using a different network structure.

In general, during encoding, hyper prior parameters zₜ are derived from the current latent SV representation yₜ, quantized, entropy coded, and output as part of the encoded data. During decoding or as part of reconstruction during encoding, the hyper prior parameters \hat{z}ₜ are reconstructed by entropy decoding (as needed) and a hyper prior decoder. The reconstructed hyper prior parameters are \hat{z}ₜ are then used by the entropy model network. For example, as shown in FIG. 5B, the hyper prior parameters \hat{z}ₜ can be derived from the current latent SV representation yₜ. Specifically, the current latent SV representation yₜ can be first encoded by a hyper prior encoder (502). The encoded yₜ is quantized by a quantizer (504) and then further encoded by an arithmetic encoder (506). The encoded output of the arithmetic encoder (506) can be decoded by an arithmetic decoder (508) to generate the hyper prior \hat{z}ₜ. Each of the hyper prior encoder (502) and hyper prior decoder (510) can include one or more convolutional layers. Example network structures of the hyper prior encoder and the hyper prior decoder for SV information are described further below with reference to FIGS. 13A and 13B, respectively. Additional details on hyper prior are described in Ballé et al., “Variational image compression with a scale hyperprior,” 6^{th} International Conference on Learning Representations, ICLR (2018). Alternatively, the hyper prior encoder and hyper prior decoder for SV information can be implemented using a different network structure.

Although only one temporal context parameter set

$${\overline{C}}_{t}^{2}$$

is shown as an input in FIG. 5A, in certain cases, the input to the hybrid entropy model network can include a different temporal context parameter set (e.g.,

$${\overline{C}}_{t}^{0} or {\overline{C}}_{t}^{1} ) .$$

In some examples, the input to the hybrid entropy model network can include two or more temporal context parameter sets (e.g.,

$${\overline{C}}_{t}^{0} , {\overline{C}}_{t}^{1} and {\overline{C}}_{t}^{2} ) .$$

As depicted in FIG. 3, the latent prior ŷₜ₋₁ can be generated by the inverse quantizer (314) and stored in a latent buffer (332). Although both temporal context parameter sets (e.g.,

$${\overline{C}}_{t}^{2} )$$

and the reconstructed latent prior ŷₜ₋₁ contain temporal information, they have different characteristics. For example, in some example implementations,

$${\overline{C}}_{t}^{2}$$

at 4× down-sampled resolution usually contains a lot of motion information. By contrast, in the example implementations, ŷₜ₋₁ is in the latent representation domain at 16× down-sampled resolution, and has more similar characteristics with the current latent SV representation yₜ. Thus,

$${\overline{C}}_{t}^{2}$$

and ŷₜ₋₁ can provide complementary and auxiliary information to improve accuracy of estimating statistical characteristics of ÿ.

In addition, in some implementations, a cascaded training strategy can be adopted so that gradients can back propagate to multiple video frames. Further details on such a cascaded training strategy in different contexts are described in Chan et al., “Basic VSR: The search for essential components in video super-resolution and beyond,” in Proceedings of the IEEE/CVF Conference on Computer Vision and Pattern Recognition. 4947-4956, 2021, and in Sheng 2021. Under such a training strategy, a propagation chain of latent representation can be formed. As a result, the connection between the latent representation of the current video frame and that of a long-range reference video frame is also established. Such connection can be very helpful for extracting the correlation across the latent representation of multiple video frames, thus resulting in more accurate prediction of the statistical distribution of ÿ.

During decoding, based on the same inputs as during encoding, the hybrid entropy model network (440) performs operations in the same order to determine statistical characteristics for the respective sets of elements, which are used in entropy decoding, and QS values per spatial area (and per channel), which are used in inverse quantization.

FIGS. 4, 5A, and 5B depict a hybrid entropy model network for encoding/decoding of a latent SV representation. The hybrid entropy model network can also be used for encoding/decoding of a latent MV representation. For encoding/decoding of MV information, the inputs to the hybrid entropy model network include hyper prior parameters mv_\hat{z}ₜ for the current latent MV representation of the current video frame and a decoded previous latent MV representation for the previous video frame mv_ŷₜ₋₁ (i.e., the latent prior). The temporal context parameter sets described above, which are derived depending on the MV values \hat{v}ₜ for the current video frame, are not input to the hybrid entropy model network for MV encoding/decoding. Before being fused by a fusion unit, the hyper prior information mv_\hat{z}ₜ for the latent MV representation is first decoded by a hyper prior decoder to generate decoded hyper prior parameters for the MV information. A latent buffer can store the decoded previous latent MV representation for the previous video frame mv_ŷₜ₋₁ (i.e., the latent prior).

### B. Dual Spatial Prior

With or without using the latent prior ŷₜ₋₁ (or mv_ŷₜ₋₁) to enrich the input, the hybrid entropy model network can also be configured to implement a dual spatial prior feature to exploit the spatial correlation within a video frame. The dual spatial prior feature can be used when encoding/decoding a current latent SV representation or current latent MV representation.

For example, to improve the operation efficiency, the dual spatial prior feature can be implemented in a two-stage estimation process based on a split checkerboard context model, as illustrated in FIG. 4. For simplification, the arithmetic encoder and decoder (e.g., 308 and 312 in FIG. 3) are omitted from the two-stage estimation of FIG. 4. More generally, the dual spatial prior feature can be implemented in a multi-stage estimation process with more than two stages. In corresponding decoding, the dual spatial prior feature is implemented in a two-stage estimation process (more generally, multi-stage estimation process).

FIG. 4 shows encoding/decoding for a current latent SV representation with the dual spatial prior feature. As described above, elements of the current latent SV representation yₜ are logically organized in three dimensions, including two spatial dimensions and one channel dimension. As shown in FIG. 4, the current latent SV representation yₜ (402) can be split into two blocks (422, 424) of elements along the channel dimension by a splitter (404). Each of the two blocks (422, 424) has the same spatial dimensions as yₜ (404) but only some of the channels. For example, assuming the total number of channels in yₜ is C, the first block (422) can include elements in the lower half channels (e.g., y_{t,k<C/2}), and the second block (424) can include elements in the upper half channels (e.g., y_{t,k≥C/2}).

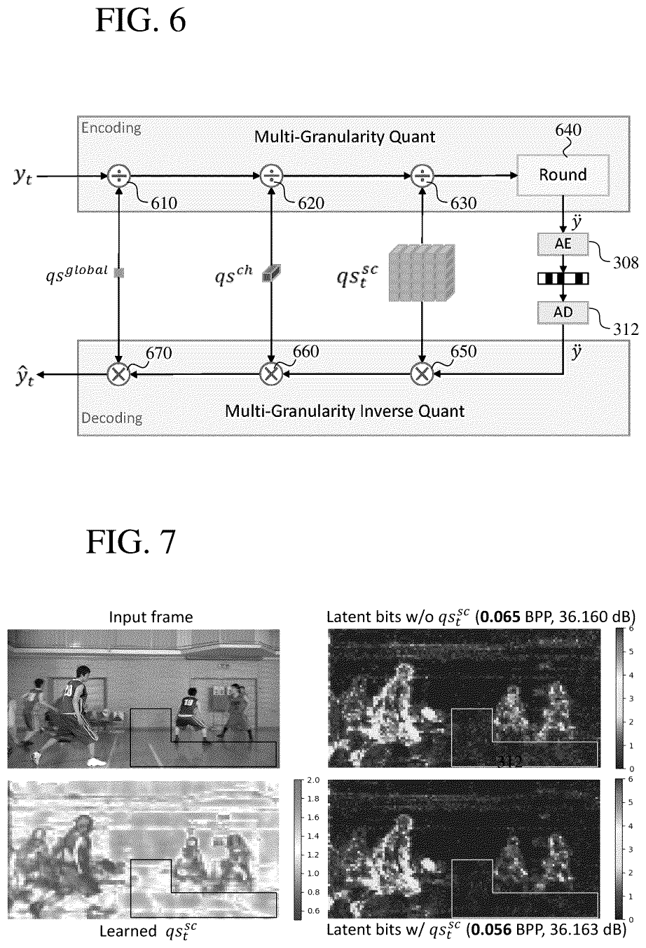

As shown in FIG. 4, the two blocks (422, 424) of elements can be quantized by a quantizer (416) to generate quantized versions of the two blocks (e.g., ÿ_{t,k<C/2} and ÿ_{t,k≥C/2}), respectively. The quantizer (416) depicted in FIG. 4 can be the quantizer (306) of FIG. 3. As described further below with reference to FIG. 6, the quantizer (416) can be configured to implement an adaptive quantization mechanism that allows quantization at multi-granularity levels.

Elements in each quantized block (e.g., ÿ_{t,k<C/2} and ÿ_{t,k≥C/2}) can be further split into two sets along the two spatial dimensions: one odd set containing elements at odd positions, and one even set containing elements at even positions. As described herein, an element is in the even position if the sum of the element's indexes in the two spatial dimensions is an even number (e.g., (i+j) % 2==0), and an element is in the odd position if the sum of the element's indexes in the two spatial dimensions is an odd number (e.g., (i+j) % 2==1). For example, elements in the first quantized block ÿ_{t,k<C/2} can be divided into a first even set (426) and a first odd set (430), and elements in the second quantized block ÿ_{t,k≥C/2} can be divided into a second odd set (428) and a second even set (432).

During the first stage of the dual spatial prior estimation process, the first statistics/parameter estimator (410) can be configured to encode elements in the first even set (426) while setting elements in the first odd set (430) to zero. Additionally, the first statistics/parameter estimator (410) can be configured to encode elements in the second odd set (428) while setting elements in the second even set (432) to zero. Encoding elements in the first even set (426) and encoding elements in the second odd set (428) can be performed simultaneously or substantially simultaneously (e.g., via parallel computing).

During the first-stage estimation process, the first statistics/parameter estimator (410) can estimate statistical characteristics (e.g., μ_{idx} and σ_{idx}, where idx={t, (i+j) % 2==0, k<C/2}) for elements in the first even set (426) and statistical characteristics (e.g., μ_{idx} and σ_{idx}, where idx={t,(i+j) % 2==1, k≥C/2}) for elements in the second odd set (428). During the first-stage estimation process, the first statistics/parameter estimator (410) can also determine QS parameters qsₜ^{sc} per spatial-area (and per-channel), which are provided to the quantizer (416).

FIG. 11 shows an example network structure of the first statistics/parameter estimator (410) (left “Parameter Estimation” structure in FIG. 11). Alternatively, the first statistics/parameter estimator (410) can be implemented using a different network structure.

After the first-step coding, the quantized first even set (426) and second odd set (428) can be fused together by the second fusion unit (412), which also accepts as input at least some of the output channels from the first statistics/parameter estimator (410), and then further generates the contexts for the second-stage estimation. FIG. 11 shows an example network structure of the second fusion unit (412) (the right “Prior Fusion” layer in FIG. 11). Alternatively, the second fusion unit (412) can be implemented using a different network structure.

During the second stage of the dual spatial prior estimation process, the second statistics estimator (414) can be configured to encode elements in the first odd set (430) and elements in the second even set (432). Similarly, encoding elements in the first odd set (430) and encoding elements in the second even set (432) can be performed simultaneously or substantially simultaneously (e.g., via parallel computing).

FIG. 11 shows an example network structure of the second statistics estimator (414) (right “Parameter Estimation” structure in FIG. 11). Alternatively, the second statistics estimator (414) can be implemented using a different network structure.

During the second-stage estimation process, the second statistics estimator (414) can estimate statistical characteristics (e.g., μ_{idx} and σ_{idx}, where idx={t,(i+j) % 2==1, k<C/2}) for elements in the first odd set (430) and statistical characteristics (e.g., μ_{idx} and σ_{idx}, where idx={1,(i+j) % 2==0, k≥C/2}) for elements in the second even set (432). Because the second fusion unit (412) fuses at least some of the results of the first statistics estimator (410), the second-stage estimation process can benefit from the contexts from all spatial positions. As a result, estimation of statistical characteristics by the second statistics estimator (414) can be more accurate by leveraging the estimation results obtained by the first statistics estimator (410).

The entropy coding for the first even set (426), second odd set (428), first odd set (430), and second even set (432) can happen concurrently using the respective statistical characteristics for the different sets of elements.

During decoding, based on the same inputs, the entropy model network (440) performs operations in the same order to determine statistical characteristics for the respective sets of elements and QS values per spatial area (and per channel). When reconstructing the current latent SV representation during decoding, statistical characteristics estimated by the first statistics/parameter estimator (410) can be used for entropy decoding of elements in the first even set (426) and the second odd set (428), and statistical characteristics estimated by the second statistics estimator (414) can be used for entropy decoding of elements in the first odd set (430) and the second even set (432). During decoding and as part of a reconstruction loop during encoding, the decoded elements in the first even set (426), second odd set (428), first odd set (430), and second even set (432) can be inversely quantized, using the QS values per spatial area (and per channel) from the entropy model network (440), by an inverse quantizer (418) to generate a reconstructed first block (434, e.g., ŷ_{t,k<C/2}) and a reconstructed second block (436, e.g., ŷ_{t,k≥C/2}), respectively. The inverse quantizer (418) depicted in FIG. 4 can be the inverse quantizer (314) of FIG. 3. As described further below with reference to FIG. 6, the inverse quantizer (418) can be configured to allow inverse quantization at multi-granularity levels. Finally, the reconstructed first block (434) and the reconstructed second block (436) can be concatenated by a concatenator (420) to generate the reconstructed current latent representation ŷₜ (438).

Compared to the conventional checkerboard context model described in He et al., “Checkerboard context model for efficient learned image compression,” in Proceedings of the IEEE/CVF Conference on Computer Vision and Pattern Recognition, 14771-14780, 2021, the split checkerboard context model described herein increases the scope of spatial context by means of channel splitting. In other words, the division of elements in the quantized version of latent representation is not only in the two spatial dimensions (e.g., based on odd or even position of the elements), but also along the channel dimension. As a result, more accurate estimation of statistical characteristics can be achieved. Additionally, for both the first and second estimation stages, the first and second quantized blocks can be added and sent to the arithmetic encoder (e.g., 308 of FIG. 3). Thus, the dual spatial prior feature described herein does not bring any additional coding delay when compared with the conventional checkerboard model described by He et al.

Importantly, the dual spatial prior feature described herein can mine the correlation across channels. For example, the quantized first even set (426) for the first-stage estimation process can also be used as a condition for encoding the second even set (432) during the second-stage estimation process. Similarly, the quantized second odd set (428) for the first-stage estimation process can also be used as a condition for encoding the first odd set (430) during the second-stage estimation process. As a result, the dual spatial prior can further squeeze the redundancy in ÿ by more efficiently exploiting the correlation across the spatial positions and the channel dimension.

It is to be understood that splitting elements of ŷ into four sets (426, 428, 430, 432) as depicted in FIG. 4 is just one particular example. Alternatively, elements of y can be divided in many different ways. For example, the splitter (404) can divide yₜ (402) along the channel dimension differently, resulting in two different blocks. In one specific example, one block can include elements in the odd channels and the other block can include elements in the even channels. In the example depicted in FIG. 4, the two blocks (422, 424) have equal number of channels (assuming Cis an even number). In other examples, the two blocks split by the splitter (404) can have different number of channels.

In some circumstances, elements of ÿ can also be split into multiple sets along the two spatial dimensions not following a checkboard pattern. For example, elements of ÿ can be split into different quadrants. In one specific example, a first set can include elements in the upper left quadrant, a second set can include elements in the lower right quadrant, and a third set can include elements in the upper right quadrant and the lower left quadrant. In such circumstances, instead of using two-stage estimation as described above, a three-stage estimation process (which can be deemed as a triple spatial prior, or, more generally, a multi-stage spatial prior) can be performed based on the same principle described herein.

More generally, elements of the current latent SV representation yₜ (and the resulting quantized version ÿ) can be split into multiple sets of elements in different channel sets along the channel dimension and different spatial position sets along the two spatial dimensions. Each of the multiple sets of elements can have a different combination of one of the different channel sets and one of the different spatial position sets. For example, FIG. 4 shows the channel dimension is divided into two channel sets (upper channels and lower channels), and the two spatial dimensions are divided into two spatial position sets (odd positions and even positions). As such, the first even set (426) includes elements in the lower half channels and at even positions, while the second odd set (428) includes elements in the upper half channels and at odd positions.

Based at least in part on a quantized version of a first set of elements among the multiple sets of elements, the statistical characteristics of a quantized version of a second set of elements among the multiple sets of elements can be estimated. For example, in FIG. 4, the statistical characteristics of the first odd set (430) and/or the second even set (432) can be estimated based in part on the first even set (426) and/or the second odd set (428). When the estimation process is divided into multiple stages, the encoding (quantized) results from a previous stage can be fused to provide an input for a subsequent estimation stage, as described above.

FIGS. 4 and 11 depict an entropy model network for encoding/decoding of a current latent SV representation using a dual spatial prior feature. The entropy model network using a dual spatial prior feature can also be used for encoding/decoding of a current latent MV representation. For encoding/decoding of MV information, the inputs to the entropy model network include hyper prior parameters mv_\hat{z}ₜ for the current latent MV representation of the current video frame. If the entropy model network is a hybrid entropy model network that uses a latent prior as an input (as described in the previous section), the inputs also include a decoded previous latent MV representation for the previous video frame mv_ŷₜ₋₁ (i.e., the latent prior). Statistical characteristics for sets of elements of the current latent MV representation can be estimated in two or more stages. For example, during a first stage of estimation, a first statistics/parameter estimator of the entropy model network estimates statistical characteristics for one or more sets of elements of a current latent MV representation and also determines QS parameters per spatial-area (and per-channel), which are provided to a quantizer, for the sets of elements of the current latent MV representation. For a second stage of estimation, the quantized set(s) of elements of the current latent MV representation from the first-stage estimation are fused with (at least some of) the output of the first statistics estimator. During the second stage of estimation, a second statistics estimator of the entropy model network estimates statistical characteristics for other set(s) of elements of the current latent MV representation. The statistical characteristics for the respective quantized sets of elements of the current latent MV representation are used in entropy coding for the respective sets of elements.

During decoding, based on the same input(s), the entropy model network performs operations in the same order to determine statistical characteristics for the respective sets of elements and QS values per spatial area (and per channel) for the latent MV representation. When reconstructing the current latent MV representation during decoding, statistical characteristics estimated by the first statistics/parameter estimator can be used for entropy decoding of elements in the first-stage set(s), and statistical characteristics estimated by the second statistics estimator can be used for entropy decoding of elements in the second-stage set(s). During decoding and as part of a reconstruction loop during encoding, the decoded elements in the respective sets of elements can be inversely quantized, using the QS values per spatial area (and per channel) from the entropy model network, by an inverse quantizer to generate reconstructed sets of MV values. As described further below, the inverse quantizer can be configured to allow inverse quantization at multi-granularity levels. Finally, the reconstructed sets of MV values can be concatenated by a concatenator to generate the reconstructed current latent MV representation mv_ŷₜ.

As noted above, the entropy model network that implements a multi-stage estimation process can be a hybrid entropy model network that accepts, as an input, a latent prior. Alternatively, the entropy model network that implements a multi-stage estimation process can operate without accepting a latent prior as input.

### C. Multi-Granularity Quantization

Conventional neural codecs cannot handle rate adjustment in a single model of trained neural codec. To achieve different rates, the entropy model of conventional neural codecs needs to be retrained by adjusting the weights according to RD criteria for the different rates, respectively. Such an approach can significantly increase the training cost and model storage burden for a neural codec. To achieve a wide rate range in a single model of trained neural codec, an adaptive quantization mechanism can be integrated with the entropy model network (e.g., the hybrid entropy model network (440) that accepts a latent prior as an input and implements a dual spatial prior feature). As described below, the adaptive quantization mechanism can be used when encoding/decoding a current latent SV representation or current latent MV representation. Similarly, the adaptive quantization mechanism can be used with a hybrid entropy model network that accepts a latent prior as input or with an entropy model network that does not accept a latent prior as input.

As shown in FIG. 4, the current latent SV representation yₜ (402), including the divided first and second blocks (422, 424), can be quantized by the quantizer (416) using three sets of quantization step (“QS”) values: a global QS value (denoted as qs^{global}) for regulating bit rate and overall quality, multiple per-channel QS values for different channels of the current latent SV representation (denoted as qs^{ch}, which can also be referred to as “channel-wise quantization step values”), and multiple per-area QS values for different spatial areas of the current latent SC representation (denoted as qs^{sc}, which can also be referred to as “spatial-channel-wise quantization step values”). As described herein, the different spatial areas are associated with different positions or regions/blocks (e.g., determined by the height, width, and channel indexes i, j, and k) of the current latent SV representation, and the different per-area QS values are channel-specific (but alternatively, the different per-area QS values can be channel-independent). For example, two different spatial areas (e.g., with different i or j indexes) in the same channel can have two different per-area QS values, and two same spatial areas (e.g., with identical i and j indexes) in two different channels can also have different per-area QS values.

The global QS value qs^{global} can be a fixed value predefined by a user as part of an overall setting of quality and bitrate. The global QS value qs^{global} can be the same parameter for the current latent SV representation and current latent MV representation, or the current latent SV representation and current latent MV representation can have different global QS values.

The per-channel QS values qs^{ch} for different channels can be configured as a part of the neural video codec system (e.g., 300), based on importance of the respective channels, and can be learned during a model training process. Each per-channel QS value can be applied to a specific channel. The per-channel QS values for different channels can be the same or different. For example, any of the per-channel QS values for the lower half channels

$$( {qs}_{k < C / 2}^{ch} )$$

can be larger than, smaller than, or the same as any of the per-channel QS values for the upper half channels

$$( {qs}_{k \geq C / 2}^{ch} ) .$$

Alternatively, a group of band of channels can share a per-channel QS value, as in a quantization matrix. The per-channel QS values qs^{ch} can be the same parameters for the current latent SV representation and current latent MV representation, or the current latent SV representation and current latent MV representation can have different per-channel QS values (e.g., because the number of channels is different for the current latent SV representation and current latent MV representation, or because the relative importance of the channels is different in the two latent representations). In some example implementations, the per-channel QS values qs^{ch} do not change over time. In this case, the per-channel QS values qs^{ch} can be defined at an encoder and decoder. Alternatively, the per-channel QS values qs^{ch} can change over time (e.g., change from one video sequence to another video sequence, change from one group of video frames to another group of video frame within one video sequence, or change from one video frame to another video frame, etc.), in which case the encoder can encode the per-channel QS values qs^{ch} and output them as part of the encoded data, and the decoder can reconstruct the per-channel QS values qs^{ch}.

The per-area QS values qs^{sc} for different spatial areas can be generated by the hybrid entropy model network (440), as described above, or other entropy model network. The current latent SV representation and current latent MV representation can have different per-area QS values qs^{sc}. In some example implementations, since the per-area QS values qs^{sc} are generated by the entropy model network during encoding and during decoding from the same inputs, the per-area QS values qs^{sc} are not encoded and transmitted in the encoded data. For example, in one specific example, the per-area QS values (qs^{sc}) for different spatial areas can be generated by the first statistical estimator (410).

In FIG. 4, the hybrid entropy model network (440) generates per-area QS values qs^{sc} for all sets of elements of the current latent representation. In some other implementations, the per-area QS values (qs^{sc}) for some spatial areas can be generated by the first statistical/parameter estimator (410), and the per-area QS values (qs^{sc}) for different spatial areas can be generated by the second statistical estimator (414), e.g., based on the encoded elements for the first odd set (430) and the second even set (432). In this case, the second statistical estimator (414) outputs the per-area QS values (qs^{sc}) for the first odd set (430) and the second even set (432) in addition to the statistical characteristics for the first odd set (430) and the second even set (432). Alternatively, the per-area QS values qs^{sc} for all sets of elements of the current latent representation can be generated by the second statistical estimator (414).

During decoding and as part of a reconstruction loop during encoding, the corresponding inverse quantization is applied. Generally, the inverse quantizer (418) can use the same global QS value qs^{global}, multiple per-channel QS values qs^{ch}, and multiple per-area QS values qs^{sc} for the inverse quantization. The global QS value qs^{global} can be transmitted to the decoder along with other encoded data in the bitstream. The overhead of transmitting qs^{global} is negligible since only a single number is transmitted for each frame or video (or two values are transmitted, if different values are used for MV information and SV information).

FIG. 6 depicts an example implementation of multi-granularity quantization and inverse quantization. As shown, the quantization can be performed in three successive stages. At a first quantization stage (610), the current latent SV representation yₜ is first quantized using the global QS value qs^{global}. At a second quantization stage (620), the output of the first quantization stage (610) is further quantized using the per-channel QS values qs^{ch} (e.g., each channel is quantized by a QS value specific to that channel). At a third quantization stage (630), the output of the second quantization stage (620) is further quantized using the per-area QS values qs^{sc} (e.g., each element is quantized by a QS value specific to a spatial location and channel of that element). The output of the third quantization stage (630) can be rounded by a rounding unit (640) to generate the final quantized version the current latent SV representation ÿₜ, which is sent to the arithmetic encoder (308) to generate a bit-stream. Although FIG. 6 depicts quantization for elements of the current latent SV representation yₜ, elements of the current latent MV representation mv_yₜ can be quantized in an analogous manner within the MV encoder.

Likewise, the inverse quantization can be performed in three successive stages but with a reversed order. As shown, the quantized version of the current latent SV representation ÿₜ is decoded from the bit stream by the arithmetic decoder (312) (or, in a reconstruction loop during encoding, conveyed from the quantizer). At a first inverse quantization stage (650), ÿₜ is first inverse quantized using the per-area QS values qs^{sc} (e.g., each element is inverse quantized by a QS value specific to a spatial location and channel of that element). At a second inverse quantization stage (660), the output of the first inverse quantization stage (650) is further inverse quantized using the per-channel QS values qs^{ch} (e.g., each channel is inverse quantized by a QS value specific to that channel). At a third inverse quantization stage (670), the output of the second inverse quantization stage (660) is further inverse quantized using the global QS value qs^{global}. The output of the third inverse quantization stage (670) produces the final reconstructed current latent SV representation St. Although FIG. 6 depicts inverse quantization for quantized elements of the current latent SV representation ÿₜ, elements of the current latent MV representation mv_ÿₜ can be inverse quantized in an analogous manner within the MV encoder or MV decoder.

FIG. 6 shows one particular order for applying the global QS value qs^{global}, multiple per-channel QS values qs^{ch}, and multiple per-area QS values qs^{sc} during quantization and inverse quantization. Alternatively, the global QS value qs^{global}, multiple per-channel QS values qs^{ch}, and multiple per-area QS values qs^{sc} can be applied in a different order during quantization and inverse quantization.

Because the global QS value is a single value which is applied to elements in all spatial positions and in all channels for a given latent representation, the qs^{global} can bring a coarse quantization effect for controlling the target rate. Because different channels carry information with difference importance, the per-channel QS values can scale or modulate quantization steps at different channels. Furthermore, different spatial positions with each channel can also have different characteristics due to the various image or video contents. Thus, the per-area QS values can be used for more precise adjustment of quantization step size for each position in each channel.

As described above, the per-area QS values qs^{sc} are generated by the entropy model network (e.g., hybrid entropy model network (440)). Thus, for each image or video frame, qs^{sc} is dynamically changed to adapt to the image or video contents. Such content adaptation is not only useful to achieve a smooth bit rate adjustment, but also can improve the final rate distortion performance by means of content-adaptive bit allocation. Specifically, more important information which is vital for the reconstruction and/or is referenced by the coding of the subsequent video frames will be allocated with smaller quantization values, and vice versa.

A visualization example is shown in FIG. 7. In this example, the upper left panel shows an input video frame. The per-area QS values qs^{sc} generated by the hybrid entropy model is shown in the lower left panel. The upper right panel shows a quantized latent representation of the input video frame without using the per-area QS values qs^{sc}. The lower right panel shows a quantized latent representation of the input video frame using the per-area QS values qs^{sc}. In this example, the hybrid entropy model learns that the moving players are more important and produces smaller per-area QS values for these regions. By contrast, the background areas (e.g., as marked by horizontal and vertical lines in the lower right corner of the panels) are associated with larger per-area QS values, thus resulting in considerable savings in bit rate. For example, the bit rate is 0.065 bit per pixel (BPP) without using the per-area QS values, but is reduced to 0.056 BPP when using the per-area QS values, thus resulting in about 13.8% BPP reduction under similar image quality.

In many of the preceding examples, each spatial location (or each combination or spatial location and channel) has its own per-area QS value. Alternatively, a per-area QS value can be shared between multiple spatially adjacent locations, e.g., for a block or window.

In many of the preceding examples, there are three stages of quantization and three stages of corresponding inverse quantization. Alternatively, there can be fewer stages or more stages. For example, there are two stages of quantization and two stages of corresponding inverse quantization, with a global QS value applied in one stage, and per-area, per-channel QS values applied in another stage. Or, as another example, there are four stages of quantization and four stages of corresponding inverse quantization, with a global QS value applied in one stage, per-channel QS values applied in another stages, and hierarchical QS values applied in the remaining stages for different levels of spatial granularity.

### VII. Example Neural Network Structures

Convolutional neural networks (“CNNs”) are used in several components of the neural video codec system (300) and neural image codec system described herein. Generally, a CNN includes one or more convolutional layers. A convolutional layer includes a set of filters (also referred to as kernels), parameters of which can be learned through a training process. The convolutional layer computes the convolutional operation of input values for an input image or a video frame (e.g., sample values, MV values for a first layer; or outputs from a previous layer for later layers) using kernels to extract fundamental features embedded in the image or video frame. The size of the kernels is typically smaller than the input image or video frame. Each kernel convolves with the image or video frame and creates an activation map (also referred to as “feature map”) made of neurons. The output volume of a convolutional layer is obtained by stacking the activation maps of all kernels along a depth dimension (example of channel dimension). In addition to convolutional layers, some CNNs can also include one or more sub-pixel convolutional layers, one or more pooling layers, and/or one or more rectified linear units (“ReLU”) correction layers. A sub-pixel convolutional layer performs a standard convolutional operation followed by a pixel-shuffling operation. Placed between two convolutional layers, a pooling layer receives a plurality of activation maps and applies a pooling operation to each of them so as to reduce the spatial dimension while preserving important characteristics of the activation maps. A ReLU correction layer acts as an activation function by replacing all negative values received as inputs by zeros.

This section describes example network structures of selected components of the neural video codec system (300) and neural image codec system. For the convolutional and sub-pixel convolutional layers depicted in the examples, the notation (K, Cin, Cout, S) indicate the kernel size, input channel number, output channel number, and stride, respectively. Generally, the stride is a kernel parameter that modifies the amount of movement over the image or video frame.

Example network structures of a contextual encoder (e.g., 304) and a contextual decoder (e.g., 316) for a current video frame xₜ and latent SV representation are shown in FIGS. 9A and 9B, respectively. In the depicted example, the inputs to the contextual encoder include the current video frame xₜ (with three input channels corresponding to three color components for the respective spatial locations of the frame) and the multi-scale temporal context parameter sets (C̅ₜ⁰, C̅ₜ¹, C̅ₜ²) at different spatial resolutions (original, 2× down-sampled, 4× down-sampled) with a total of 64 channels for each of the multi-scale temporal context parameter sets. The output of the contextual encoder is the current latent SV representation yₜ with a total of 96 channels at 16× down-sampled spatial resolution. The inputs to the contextual decoder include the decoded (reconstructed) current latent SV representation ŷₜ. Conditioned on C̅ₜ¹ and C̅ₜ², high-resolution estimated current feature parameter set \hat{F}ₜ with 32 channels can be decoded. As shown, the contextual encoder can include four convolutional layers, and the contextual decoder can include four sub-pixel convolutional layers. Additionally, each of the contextual encoder and the contextual decoder can include two bottleneck residual blocks, which are used to reduce the complexity of the middle layer, as described in Sheng 2021. The kernel size and stride of convolutional layer for the bottleneck residual blocks are set to 3 and 1, respectively. Thus, only the input and output channel numbers are shown for the bottleneck residual blocks for simplicity.

An example network structure for a hybrid entropy model network (e.g., 440) is shown in FIG. 11. The inputs to the hybrid entropy model network include decoded hyper prior parameters with 192 channels, a temporal context prior with 192 channels, and a latent prior (i.e., the decoded previous latent SV representation for the previous video frame ŷₜ₋₁) with 96 channels.

The decoded hyper prior parameters can be generated by the hyper prior decoder (510) of FIG. 5A by decoding the hyper prior \hat{z}ₜ, which is previously generated from the current latent representation yₜ, as depicted in FIG. 5B. As described above with reference to FIG. 5A, the temporal context prior can be generated by the temporal context encoder (520). Specifically, the inputs to the temporal context encoder include a temporal context parameter set C̅ₜ², and the output is the temporal context prior. An example network structure for the temporal context encoder is shown in FIG. 12. As shown, the temporal context encoder can include two convolutional layers separated by a leaky ReLU layer. Example network structures of a hyper prior encoder (e.g., 502) and a hyper prior decoder (e.g., 510) are shown in FIGS. 13A and 13B, respectively. As shown, the hyper prior encoder can include five convolutional layers separated by four leaky ReLU layers, whereas the hyper prior decoder can include three convolutional layers and two sub-pixel convolutional layers, which are separated by four leaky ReLU layers.

Referring back to FIG. 11, the hybrid entropy model network is configured to perform the estimation process in two stages. The first stage has one convolutional layer acting as the first fusion unit (e.g., 408) for prior fusion, followed by two convolutional layers and two leaky ReLU layers acting together as the first statistics/parameter estimator (e.g., 410). In the first-stage estimation, the hybrid entropy model network not only estimates the mean and scale parameters of the probability distribution for two parts of quantized latent current latent SV representation: ÿ_{t,(i+j) % 2==0,k<C/2} and ÿ_{t,(i+j) % 2==1,k≥C/2} (e.g., the first even set (426) and the second odd set (428)), but also generates the per-area QS values qs^{sc}. The second stage has one convolutional layer acting as the second fusion unit (e.g., 412), followed by two convolutional layers and two leaky ReLU layers acting together as the second statistics estimator (e.g., 414). In the second-stage estimation, the quantized latent SV representations from the first-stage parts are fused to the input, and then the hybrid entropy model network estimates the mean and scale parameters of the probability distribution for other two parts of quantized latent current latent SV representation: ÿ_{t,(i+j) % 2==1,k<C/2} and ÿ_{t,(i+j) % 2==0,k≥C/2} (e.g., the first odd set (430) and the second even set (432)).

Example network structures of a MV contextual encoder (e.g., in MV encoder 328) and a MV contextual decoder (e.g., in MV decoder 330) are shown in FIGS. 8A and 8B, respectively. The input to the MV contextual encoder is the current set of MV values vₜ with two channels for horizontal and vertical MV components, respectively, and the output of the MV contextual encoder is the current latent MV representation for the current MV values, denoted as mv_yₜ, which has a 16× down-sampled spatial resolution and 64 channels. The MV contextual decoder generally follows a reverse structure. As shown, the MV contextual encoder has one convolutional layer and the MV contextual decoder has one sub-pixel convolutional layer. Both the MV contextual encoder and MV contextual decoder include a plurality of residual blocks, including down-sample residual blocks in the MV contextual encoder and up-sample residual blocks in the MV contextual decoder. More details on these residual blocks can be found in Sheng 2021.

In some example implementations, the MV encoder (328) and MV decoder (330) include an entropy model network analogous to one of the entropy model networks described above for SV information. For example, the MV encoder (328) and MV decoder (330) can include a hybrid entropy model network with a network structure similar to the network structure shown in FIG. 11, but without the temporal context prior (based on the temporal context parameter set(s)) as an input. Instead, the inputs include the hyper prior for the current latent MV representation and the latent prior (previous latent MV representation). The number of input channels is different for the first prior fusion layer (e.g., lower by 192 channels), and the number of output channels and input channels of the respective layers of the network structure can be reduced accordingly, but the overall organization can be the same.

In some example implementations, the MV encoder (328) includes a hyper prior encoder and hyper prior decoder, and the MV decoder (330) includes a hyper prior decoder, analogous to those described above for SV information. For example, the hyper prior encoder and hyper prior decoder for the current latent MV representation can have network structures similar to the hyper prior encoder and hyper prior decoder shown in FIGS. 13A and 13B.

An example network structure for a frame generator (e.g., 318) is shown in FIG. 10A. In the depicted example, the frame generator has a W-Net based structure. Further details on the W-Net based structure, in a different context, are described in Xia and Kulis, “W-net: A deep model for fully unsupervised image segmentation,” arXiv preprint arXiv:1711.08506 (2017). Such a network design can effectively enlarge the receptive field of the model with acceptable complexity, and improve the generation ability for the model. As shown, the inputs to the frame generator include the high-resolution current feature parameter set \hat{F}ₜ (output from the contextual decoder) with 32 channels and the temporal context parameter set C̅ₜ⁰, which has the original spatial resolution as the input video frame and 64 channels. The outputs of the frame generator include the final reconstructed current video frame \hat{x}ₜ, as well as a feature parameter set that can be used for encoding/decoding a subsequent video frame. The W-Net depicted in FIG. 10A is formed by bridging two U-Net and includes one convolutional layer and two sub-pixel convolutional layers, as well as a plurality of polling layers and residual blocks, including residual blocks with attention. An example network structure of a residual block with attention is further illustrated in FIG. 10B. In the depicted example, the residual block with attention includes three convolutional layers, one polling layer, and several activation layers including two ReLU layers, two linear activation layers, and a sigmoid activation layer.

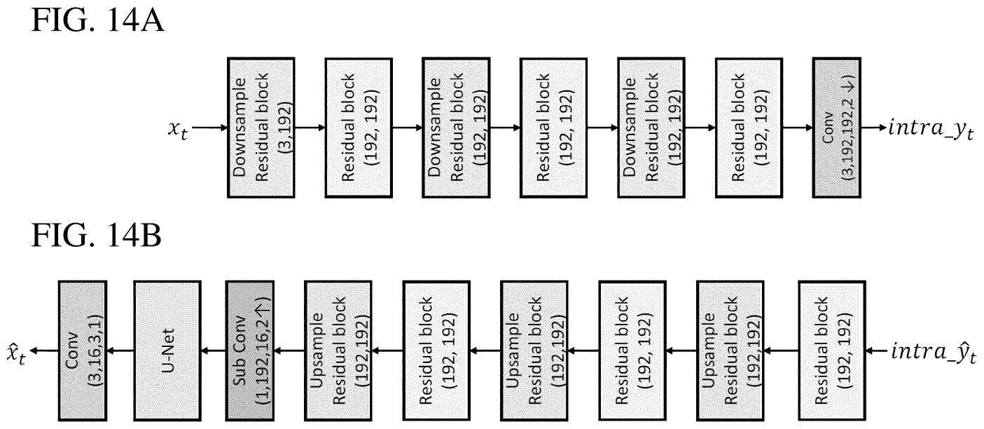

As described above, the hybrid entropy model network described herein supports content-adaptive quantization which allows handling of multiple rates in a single model. Certain aspects of the entropy model network can be used for image coding/decoding as well as video coding/decoding. Thus, a neural image codec system supporting such capability can be implemented for intra-frame coding/decoding. Example network structures of a neural image contextual encoder and a neural image contextual decoder are depicted in FIGS. 14A-14B, respectively. As shown, the neural image contextual encoder includes a convolutional layer and a plurality of residual blocks, including down-sample residual blocks. The neural image contextual decoder includes one convolutional layer, one sub-pixel convolutional layer, one U-Net, and a plurality of residual blocks, including up-sample residual blocks. The U-Net (which can have a similar network structure as the one depicted in FIG. 10A) is incorporated in the neural image contextual decoder to improve the generation ability of neural image codec system.

In some examples, the same multi-granularity quantization/inverse quantization described above can also be used in the neural image encoder/decoder, for example, to generate a quantized version of an intra latent SV representation intra_yₜ for the current video frame xₜ, and to reconstruct a version of the intra SV representation intra_ŷₜ.

In some examples, a similar entropy model network can be used to determine statistical characteristics of the quantized version of an intra latent SV representation intra_yₜ, and to generate QS values. For example, the only difference can be the input to the entropy model. For the neural image codec, the input of the entropy model network can include only the corresponding hyper prior for the intra latent SV representation, without a latent prior and temporal context prior (since there is no previous frame to use in coding/decoding).

### VIII. Example Methods of Neural Encoding and Neural Decoding

This section describes example methods of neural encoding and neural decoding. The methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices). The illustrated actions can be described from alternative perspectives while still implementing the technologies. For example, “receive” can also be described as “send” from a different perspective.

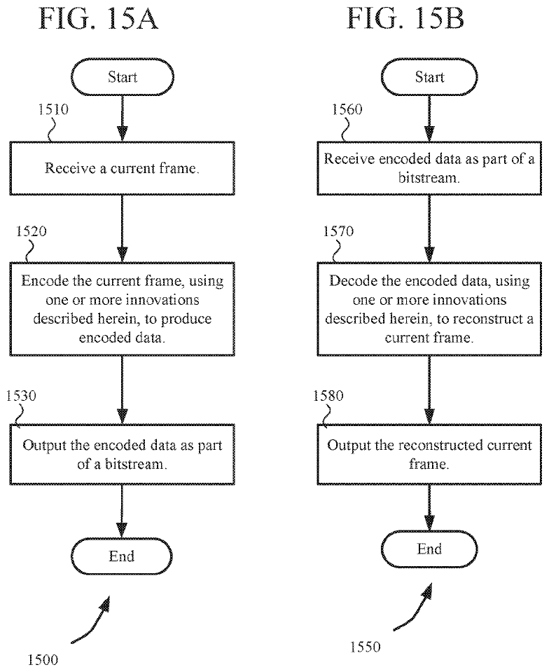

FIGS. 15A-15B are flowcharts illustrating overall methods 1500, 1550 for neural encoding and neural decoding, respectively, and can be implemented, for example, by the video codec system (300) of FIG. 3 or another neural video codec system or neural image codec system.

As shown in FIG. 15A, the neural encoding method 1500 starts at 1510, where a current frame is received by a neural encoder. In certain examples, the neural encoder can be a neural video encoder (e.g., 340) configured to encode a video frame (e.g., 302), as depicted in FIG. 3. In certain examples, the neural encoder can be a neural image encoder configured to encode a single image. For example, the neural encoder can be the motion vector encoder (328), which is configured to encode a set of MV values vₜ. Or, as another example, the neural encoder can be configured to encode sample values. At 1520, the neural encoder can encode the current frame to produce encoded data. Then at 1530, the neural encoder can output the encoded data as part of a bitstream.

As shown in FIG. 15B, the neural decoding method 1550 starts at 1560, where encoded data as part of a bitstream can be received by a neural decoder. In certain examples, the neural decoder can be a neural video decoder (e.g., 350) configured to generate a decoded video frame (e.g., 320), as depicted in FIG. 3. In certain examples, the neural decoder can be a neural image decoder configured to decode a single image. For example, the neural decoder can be the motion vector decoder (330) which is configured to generate a decoded set of MV values Dt. Or, as another example, the neural decoder can be configured to decode sample values. At 1570, the neural decoder can decode the encoded data to reconstruct a current frame. Then at 1580, the neural decoder can output the reconstructed current frame.

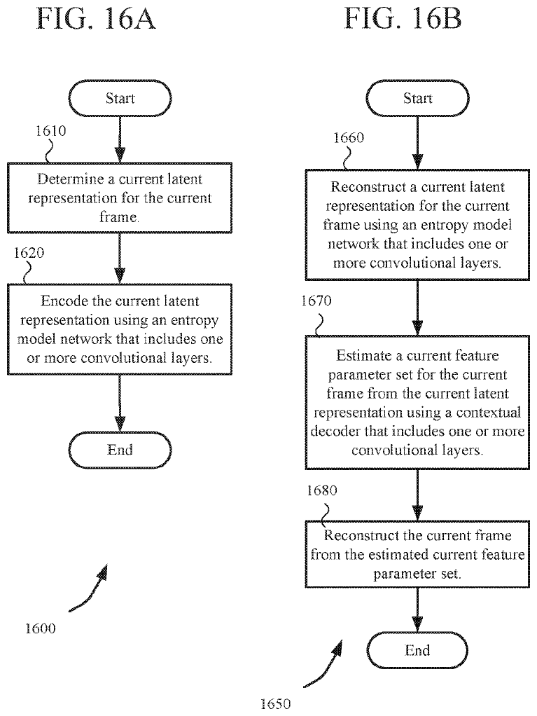

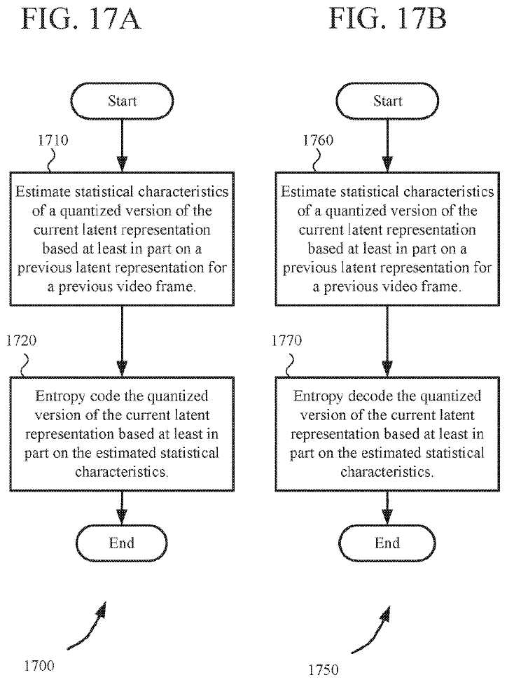

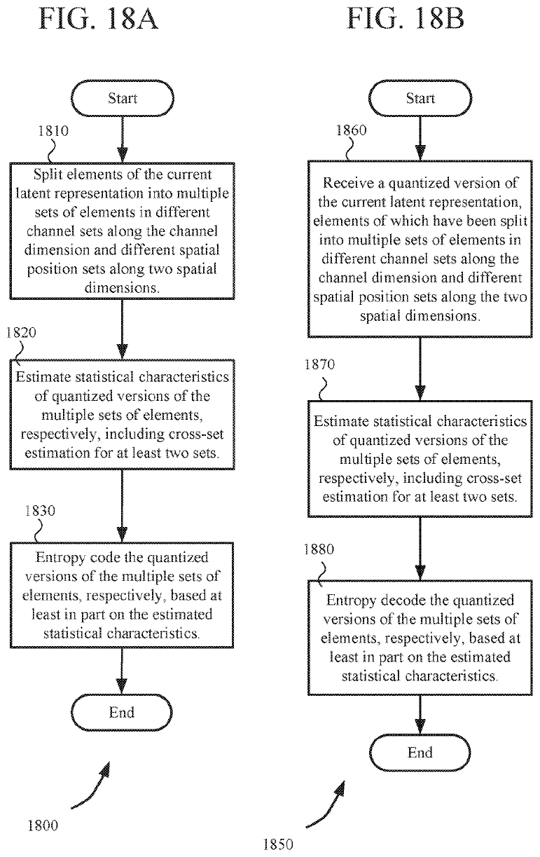

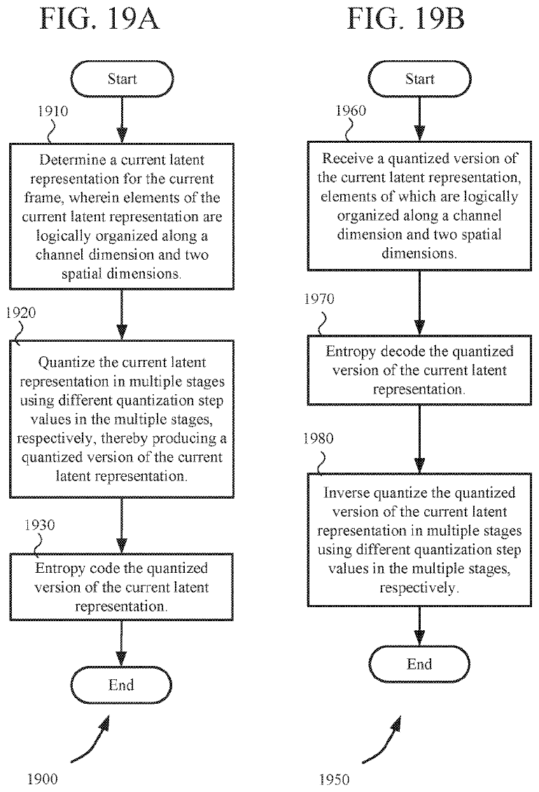

FIG. 16A shows an example method 1600 of encoding the current frame, which can be used in combination with the approach shown in FIG. 17A, FIG. 18A, and/or FIG. 19A, as described below. FIG. 16B shows an example method 1650 of decoding the encoded data, which can be used in combination with the approach shown in FIG. 17B, FIG. 18B, and/or FIG. 19B, as described below.

As shown in FIG. 16A, the neural encoder can determine a current latent representation (e.g., yₜ, mv_yₜ) for the current frame at 1610. Then at 1620, the neural encoder can encode the current latent representation using an entropy model network (e.g., 310) that includes one or more convolutional layers.

As shown in FIG. 16B, at 1660, the neural decoder can reconstruct a current latent representation for the current frame using an entropy model network (e.g., 310) that includes one or more convolutional layers. At 1670, the neural decoder can estimate a current feature parameter set (e.g., \hat{F}ₜ) for the current frame from the current latent representation using a contextual decoder (e.g., 316) that includes one or more convolutional layers. Then at 1680, the neural decoder can reconstruct the current frame from the estimated current feature parameter set.

FIG. 17A shows an example method 1700 of encoding the current latent representation by using a latent prior as an input to the entropy model network. Correspondingly, FIG. 17B shows an example method 1750 of reconstructing the current latent representation for the current frame by using a latent prior as an input to the entropy model network. The neural encoder implementing the method 1700 is a neural video encoder, and the neural decoder implementing the method 1750 is a neural video decoder.

As shown in FIG. 17A, at 1710, the neural encoder can (as part of an entropy model network) estimate statistical characteristics (e.g., mean values, scale values for a probability distribution function) of a quantized version of the current latent representation (e.g., ÿₜ, mv_ÿₜ) based at least in part on a previous latent representation for a previous video frame (e.g., ŷₜ₋₁, mv_ŷₜ₋₁). Then at 1720, the neural encoder can entropy code the quantized version of the current latent representation based at least in part on the estimated statistical characteristics.

For example, the current latent representation is a current latent SV representation for the current video frame, and the previous latent representation is a previous latent SV representation for the previous video frame. In this case, when the neural encoder determines the current latent representation, the neural encoder determines the current latent SV representation using a contextual encoder that includes one or more convolutional layers.

Or, as another example, the current latent representation is a current MV representation for the current video frame, and the previous latent representation is a previous latent MV representation for the previous video frame. In this case, when the neural encoder determines the current latent representation, the neural encoder uses motion estimation to determine MV values for the current video frame relative to a previous video frame, and determines the current latent MV representation from the MV values using a MV contextual encoder.

The neural encoder can quantize the current latent representation, thereby producing the quantized version of the current latent representation. In doing so, the neural encoder can apply at least some QS values (such as per-area QS values) that are determined using the entropy model network based at least in part on the previous latent representation.

As shown in FIG. 17B, at 1760, the neural decoder can (using an entropy model network) estimate statistical characteristics (e.g., mean values, scale values for a probability distribution function) of a quantized version of the current latent representation (e.g., ÿₜ, mv_ÿₜ) based at least in part on a previous latent representation for a previous video frame (e.g., ŷₜ₋₁, mv_ŷₜ₋₁). Then at 1770, the neural decoder can entropy decode the quantized version of the current latent representation based at least in part on the estimated statistical characteristics.

For example, the current latent representation is a current latent SV representation for the current video frame, and the previous latent representation is a previous latent SV representation for the previous video frame. In this case, the neural decoder can estimate a current feature parameter set for the current video frame from the current latent SV representation using a contextual decoder, reconstruct the current video frame from the estimated current feature parameter set, and output the reconstructed current video frame.

Or, as another example, the current latent representation is a current latent MV representation for the current video frame, and the previous latent representation is a previous latent MV representation for the previous video frame. In this case, the neural decoder can determine MV values for the current video frame from the current latent MV representation using a MV contextual decoder.

The neural decoder can inverse quantize the quantized version of the current latent representation. In doing so, the neural decoder can apply at least some QS values (such as per-area QS values) that are determined using the entropy model network based at least in part on the previous latent representation.

During encoding or decoding, the estimation of the statistical characteristics using the entropy model network can also be based at least in part on other inputs such as hyper prior parameters for the current video frame (generated from the current latent representation using a hyper prior encoder) and/or temporal context parameter set(s) for the current video frame (generated from a previous feature parameter set for the previous video frame and MV values for the current video frame using a temporal context mining network).

FIG. 18A shows an example method 1800 of encoding the current latent representation using a dual spatial prior in the entropy model network. Correspondingly, FIG. 18B shows an example method 1850 of reconstructing the current latent representation using a dual spatial prior in the entropy model network. The neural encoder implementing the method 1800 can be either a neural video encoder or a neural image encoder. The neural decoder implementing the method 1850 can be either a neural video decoder or a neural image decoder.

As shown in FIG. 18A, at 1810, the neural encoder can (before estimation with an entropy model network) split elements of a current latent representation (e.g., yₜ, mv_yₜ) into multiple sets of elements in different channel sets along a channel dimension and different spatial position sets along two spatial dimensions. Each of the multiple sets of elements has a different combination of one of the different channel sets and one of the different spatial position sets. At 1820, the neural encoder can (as part of the entropy model network) estimate statistical characteristics (e.g., mean values, scale values for a probability distribution function) of quantized versions (e.g., ÿₜ, mv_ÿₜ) of the multiple sets of elements, respectively. Specifically, based at least in part on the quantized version of a first set of elements among the multiple sets of elements, the neural encoder can estimate the statistical characteristics of the quantized version of a second set of elements among the multiple sets of elements. Then at 1830, the neural encoder can entropy code the quantized versions of the multiple sets of elements, respectively, based at least in part on the estimated statistical characteristics.

For example, the current latent representation is a current latent SV representation for the current frame. In this case, when the neural encoder determines the current latent representation, the neural encoder determines the current latent SV representation using a contextual encoder.

Or, as another example, the current latent representation is a current latent MV representation for the current frame. In this case, when the neural encoder determines the current latent representation, the neural encoder uses motion estimation to determine MV values for the current frame relative to a previous frame, and determines the current latent MV representation from the MV values using a MV contextual encoder.

The neural encoder can quantize the current latent representation, thereby producing the quantized versions of the multiple sets of elements for the current latent representation. In doing so, the neural encoder can apply at least some QS values (such as per-area QS values) that are determined using the entropy model network.

As shown in FIG. 18B, at 1860, the neural decoder can receive a quantized version of a current latent representation (e.g., ÿₜ, mv_ÿₜ). Elements of the current latent representation are logically organized along a channel dimension and two spatial dimensions. Elements of the quantized version of the current latent representation have been split into multiple sets of elements in different channel sets along the channel dimension and different spatial position sets along the two spatial dimensions. Each of the multiple sets of elements has a different combination of one of the different channel sets and one of the different spatial position sets. At 1870, the neural decoder can (using the entropy model network) estimate statistical characteristics (e.g., mean values, scale values for a probability distribution function) of quantized versions (e.g., ÿₜ, mv_ÿₜ) of the multiple sets of elements, respectively. Specifically, based at least in part on the quantized version of a first set of elements among the multiple sets of elements, the neural decoder can estimate statistical characteristics of the quantized version of a second set of elements among the multiple sets of elements. Then at 1880, the neural decoder can entropy decode the quantized versions of the multiple sets of elements, respectively, based at least in part on the estimated statistical characteristics.

For example, the current latent representation is a current latent SV representation for the current frame. In this case, the neural decoder can estimate a current feature parameter set for the current frame from the current latent SV representation using a contextual decoder, reconstruct the current frame from the estimated current feature parameter set, and output the reconstructed current frame.

Or, as another example, the current latent representation is a current latent MV representation for the current frame. In this case, the neural decoder can determine MV values for the current frame from the current latent MV representation using a MV contextual decoder.

The neural decoder can inverse quantize the quantized versions of the multiple sets of elements for the current latent representation. In doing so, the neural decoder can apply at least some QS values (such as per-area QS values) that are determined using the entropy model network.

The number of sets of elements depend on implementation. In some example implementations, for a dual spatial prior feature, the multiple sets of elements include (a) a first set of elements that has elements in a first channel set among the different channel sets and in a first spatial position set among the different spatial position sets, (b) a second set of elements that has in the first channel set and in a second spatial position set among the different spatial position sets, (c) a third set of elements that has elements in a second channel set among the different channel sets and in the second spatial position set, and (d) a fourth set of elements that has elements in the second channel set and in the first spatial position set. For example, the first channel set includes a lower half of channels, and the second channel set includes an upper half of channels. Or, the first channel set includes even channels, and the second channel set includes odd channels. The first spatial position set can include even positions while the second spatial position set includes odd positions, or vice versa. Alternatively, the elements of the current latent representation are split into more or fewer sets of elements.

FIG. 19A shows an example method 1900 of performing multi-granularity quantization. Correspondingly, FIG. 19B shows an example method 1950 of performing multi-granularity inverse quantization. The neural encoder implementing the method 1900 can be either a neural video encoder or a neural image encoder. The neural decoder implementing the method 1950 can be either a neural video decoder or a neural image decoder.

As shown in FIG. 19A, at 1910, the neural encoder can determine a current latent representation (e.g., yₜ, mv_yₜ) for the current frame. Elements of the current latent representation are logically organized along a channel dimension and two spatial dimensions. At 1920, the neural encoder can quantize the current latent representation in multiple stages using different quantization step values (e.g., qs^{global}, qs^{ch}, and qs^{sc}) in the multiple stages, respectively, thereby producing a quantized version (e.g., ÿₜ, mv_ÿₜ) of the current latent representation. Then at 1930, the neural encoder can entropy code the quantized version of the current latent representation.

For example, the current latent representation is a current latent SV representation for the current frame. In this case, when the neural encoder determines the current latent representation, the neural encoder determines the current latent SV representation using a contextual encoder.

Or, as another example, the current latent representation is a current latent MV representation for the current frame. In this case, when the neural encoder determines the current latent representation, the neural encoder uses motion estimation to determine MV values for the current frame relative to a previous frame, and determines the current latent MV representation from the MV values using a MV contextual encoder.

The neural encoder can estimate statistical characteristics of the quantized version of the current latent representation using an entropy model network, and the entropy coding can use such statistical characteristics. The neural encoder can also use the entropy model network to determine at least some of the QS values.

As shown in FIG. 19B, at 1960, the neural decoder can receive a quantized version (e.g., ÿₜ, mv_ÿₜ) of a current latent representation, elements of which are logically organized along a channel dimension and two spatial dimensions. At 1970, the neural decoder can entropy decode the quantized version of the current latent representation. Then at 1980, the neural decoder can inverse quantize the quantized version of the current latent representation in multiple stages using different quantization step values (e.g., qs^{global}, qs^{ch} and qs^{sc}) in the multiple stages, respectively.

For example, the current latent representation is a current latent SV representation for the current frame. In this case, the neural decoder can estimate a current feature parameter set for the current frame from the current latent SV representation using a contextual decoder, reconstruct the current frame from the estimated current feature parameter set, and output the reconstructed current frame.

Or, as another example, the current latent representation is a current latent MV representation for the current frame. In this case, the neural decoder can determine MV values for the current frame from the current latent MV representation using a MV contextual decoder.

The neural decoder can estimate statistical characteristics of the quantized version of the current latent representation using an entropy model network, and the entropy decoding can use such statistical characteristics. The neural decoder can also use the entropy model network to determine at least some of the QS values.

During encoding or decoding, the different QS values used for quantization (encoding) or inverse quantization (encoding/reconstruction or decoding) can include a global QS value for regulating bit rate and overall quality. The encoded data can include one or more syntax elements that indicate the global QS value, which is permitted to vary within a range. The different QS values can also include multiple per-channel QS values for different channels of the current latent representation. The multiple per-channel QS values can be pre-defined. Alternatively, the multiple per-channel QS values can vary over time, in which case the encoded data can include syntax elements that indicate the multiple per-channel QS values. The different QS values can also include multiple per-area QS values for different spatial areas of the current latent representation. The different spatial areas can be associated with different positions or regions of the current latent representation. The different per-area QS values can be channel-specific or channel-independent. Alternatively, the different QS values include other and/or additional QS values.

In some example implementations, for quantization, the multiple stages include (a) a first stage that includes using a global QS value to quantize respective elements of the current latent representation, (b) a second stage that includes using multiple per-channel QS values to quantize the respective elements of the current latent representation in different channels, and (c) a third stage that includes using per-area QS values to quantize the respective elements of the current representation in different spatial areas for the different channels. For inverse quantization, the multiple stages include (c′) a first stage that includes using per-area QS values to inverse quantize respective elements of the current representation in different spatial areas for different channels, (b′) a second stage that includes using multiple per-channel QS values to inverse quantize the respective elements of the current latent representation in the different channels, and (a′) a third stage that includes using a global QS value to inverse quantize the respective elements of the current latent representation. Alternatively, the stages of quantization and inverse quantization can be performed in a different order.

### IX. Example Experimental Results

Experimental studies have been conducted to evaluate the performance of the neural video codec technology described herein.

For training of the neural video codec in experimental scenarios, training data is obtained from Vimeo-90k as described in Xue et al., “Video Enhancement with Task-Oriented Flow,” International Journal of Computer Vision (IJCV) 127, 8:1106-1125, 2019. The videos are randomly cropped into 256×256 patches. The testing uses the same test sequences described in Sheng 2021. All the sequences are widely used in traditional and neural video codecs, including HEVC Class B, C, D, E, and RGB. In addition, the 1080p videos from UVG and MCL-JCV datasets are also tested. The UVG dataset is described in Mercat et al., “UVG dataset: 50/120 fps 4K sequences for video codec analysis and development,” in Proceedings of the 11th ACM Multimedia Systems Conference. 297-302, 2020. The MCL-JCV dataset is described in Wang et al., “MCL-JCV: a JND-based H. 264/AVC video quality assessment dataset,” in 2016 IEEE International Conference on Image Processing (ICIP). IEEE, 1509-1513 (2016).

For the training of the neural video codec in experimental scenarios, 96 frames are tested for each video. To get closer to a practical scenario, the intra period is set to 32. The training uses low delay encoding settings, as in most existing works. The compression ratio is measured by BD-Rate described in Bjontegaard, “Calculation of average PSNR differences between RDcurves,” VCEG-M33 (2001), where negative numbers indicate bitrate saving and positive numbers indicate bitrate increase. Besides the x265 encoder using the very slow preset, the benchmarks for comparison also included HM-16.20 and VTM-13.2, which represent the best encoder for the H.265 standard and H.266 standard, respectively. For HIM and VTM, the configuration with the highest compression ratio is used. The experimental results are compared to existing state-of-the-art neural video codecs including DVC_Pro, MLVC, RLVC, DCVC, and Sheng 2021. The DVC_Pro codec is described in Lu, et al., “An end-to-end learning framework for video compression,” IEEE Transactions on Pattern Analysis and Machine Intelligence, 43 (10): 3292-3308 (2020). The MLVC codec is described in Lin et al., “M-LVC: multiple frames prediction for learned video compression,” in Proceedings of the IEEE/CVF Conference on Computer Vision and Pattern Recognition, 2020. The RLVC codec is described in Yang, et al., “Learning for Video Compression with Recurrent Auto-Encoder and Recurrent Probability Model,” IEEE Journal of Selected Topics in Signal Processing 15 (2): 388-401, 2021. The DCVC codec is described in Li et al., “Deep contextual video compression,” Advances in Neural Information Processing Systems 34 (2021).

For training the neural video codec, the entropy model and quantization for the current latent representation of the MV values vₜ follow the manner of the entropy model and quantization of the current latent SV representation yₜ. The key difference is the input of entropy model. In the coding of the current latent representation for the MV values vₜ, the inputs are the corresponding hyper prior and the latent prior, i.e., the quantized latent MV representation of the MV values from the previous frame. There is no temporal context prior, as the generation of temporal context depends on the decoded MV values. Also, a neural image codec is trained to support the capability of having multiple rates in a single trained model for intra coding, as described above with reference to FIGS. 14A-14B.

During the training, the loss function includes the distortion and rate: Loss=λ·D+R, where D refers to the distortion between the input current video frame and the reconstructed current video frame. For different visual targets, the distortion can, for example, be L₂ loss or MS-SSIM, which is described in Wang et al., “Multiscale structural similarity for image quality assessment,” in the Thirty-Seventh Asilomar Conference on Signals, Systems & Computers, Vol. 2. IEEE, 1398-1402, 2003. R represents the bits used for encoding the quantized latent SV representation ÿₜ and the quantized latent representation of MV values, each of which is associated with a respective hyper prior.

For the training of the neural video codec in experimental scenarios, the training uses a multi-stage training approach generally as described in Sheng 2021. In addition, to support multiple rates in a single model, the experiments use different λ values in different optimization steps. To simply the training, four λ values (85, 170, 380, 840) are used. Four random qs^{global} values are set and learned via the RD loss with each corresponding λ value. It is noted that, although only four λ values are used in the training, the model still can achieve a wide rate range by adjusting qs^{global} during the testing.

The result of the training is a neural codec for which parameters are set for convolutional layers and other layers in the network structures of the respective components at the neural encoder and neural decoder. In some example implementations, per-channel QS values are also defined.

Experimental results show that the neural video codec technology described herein has improved performance compared to existing neural video codec technologies, including encoders for the latest traditional standard, the H.266 standard. For example, the experimental results show that the neural video codec technology described herein achieves 67.4% and 57.1% bitrate savings over DVCPro and DCVC on UVG dataset, respectively. Moreover, the neural video codec technology described herein achieves an average of 4.7% bitrate saving over VTM. This represents the first neural video codec that outperforms VTM using the highest compression ratio configuration. In particular, the neural video codec technology described herein performs better for 1080p videos (HEVC B, HEVC RGB, UVG, MCL-JCV). These results indicate the effectiveness of the hybrid entropy model on exploiting the correlation from volumed data. When oriented to MS-SSIM, the experimental results show that the neural video codec technology described herein also leads to a significant improvement, e.g., a 46.4% bitrate saving over VTM.

As described above, the neural video codec technology described herein can achieve multiple rates in a single model. The global QS value qs^{global} can be flexibly adjusted during the testing. It serves the similar role of quantization parameter in traditional video codecs. During the training, qs^{global} can be guided by the RD loss. In the experiments, 30 qs^{global} values are manually generated by interpolating between the maximum and minimum of the learned qs^{global} values. The experimental results confirm that one single model can achieve fine-grained rate control without any outlier. By contrast, previous methods such as DCVC and Sheng 2021 need different models for each rate point.

Complexity of the models can be compared in terms of model size, MACs (multiply-accumulate), peak feature usage, encoding time, and decoding time. The experiments use a 1080p video frame as an input to measure the numbers. For the encoding/decoding time, the time on V100 GPU, including the time of writing to and reading from bitstream, is measured. Because the neural video codec technology described herein supports multi-rate in a single model, it significantly reduces the model training and storage burden. Specifically, the neural video codec technology described herein results in a significant reduction of encoding/decoding time compared to DCVC, which uses the parallel-unfriendly auto-regression prior model.

### V. Features

Different embodiments may include one or more of the inventive features shown in the following table of features.

| | |
|---|---|
| # | Feature |

A. Hybrid Entropy Model Network Using Previous Latent Representation

| | |
|---|---|
| A1 | In a computer system that implements a neural video encoder, a method comprising: |
| | receiving a current video frame; |
| | encoding the current video frame to produce encoded data, wherein the |
| | encoding the current video frame comprises: |
| | determining a current latent representation for the current video |
| | frame; and |
| | encoding the current latent representation using an entropy model |
| | network that includes one or more convolutional layers, wherein the |
| | encoding the current latent representation using the entropy model network |
| | comprises: |
| | estimating statistical characteristics of a quantized version of |
| | the current latent representation based at least in part on a previous |
| | latent representation for a previous video frame; and |
| | entropy coding the quantized version of the current latent |
| | representation based at least in part on the estimated statistical |
| | characteristics; and |
| | outputting the encoded data as part of a bitstream. |
| A2 | The method of A1, further comprising: |
| | quantizing the current latent representation, thereby producing the quantized |
| | version of the current latent representation. |
| A3 | The method of A2, wherein the encoding the current latent representation using the |
| | entropy model network further comprises: |
| | determining at least some quantization step (QS) values for the current latent |
| | representation based at least in part on the previous latent representation, wherein |
| | the quantizing uses the at least some QS values. |
| A4 | The method of A1, wherein the current latent representation is a current latent |
| | sample value (“SV”) representation for the current video frame, wherein the |
| | previous latent representation is a previous latent SV representation for the previous |
| | video frame, and wherein the determining the current latent representation comprises |
| | determining the current latent SV representation using a contextual encoder that |
| | includes one or more convolutional layers. |
| A5 | The method of A1, wherein the current latent representation is a current latent |
| | motion vector (“MV”) representation for the current video frame, wherein the |
| | previous latent representation is a previous latent MV representation for the previous |
| | video frame, and wherein the determining the current latent representation |
| | comprises: |
| | using motion estimation to determine MV values for the current video frame |
| | relative to the previous video frame; and |
| | determining the current latent MV representation from the MV values using |
| | an MV contextual encoder that includes one or more convolutional layers. |
| A6 | In a computer system that implements a neural video decoder, a method comprising: |
| | receiving encoded data as part of a bitstream; and |
| | decoding the encoded data to reconstruct a current video frame, wherein the |
| | decoding the encoded data comprises: |
| | reconstructing a current latent representation for the current video |
| | frame using an entropy model network that includes one or more |
| | convolutional layers, wherein the reconstructing the current latent |
| | representation comprises: |
| | estimating statistical characteristics of a quantized version of |
| | the current latent representation based at least in part on a previous |
| | latent representation for a previous video frame; |
| | entropy decoding the quantized version of the current latent |
| | representation based at least in part on the estimated statistical |
| | characteristics. |
| A7 | The method of A6, further comprising: |
| | inverse quantizing the quantized version of the current latent representation. |
| A8 | The method of A7, wherein the reconstructing the current latent representation using |
| | the entropy model network further comprises |
| | determining at least some quantization step (QS) values for the current latent |
| | representation based at least in part on the previous latent representation, wherein |
| | the inverse quantizing uses the at least some QS values. |
| A9 | The method of A6, wherein the current latent representation is a current latent |
| | sample value (“SV”) representation for the current video frame, wherein the |
| | previous latent representation is a previous latent SV representation for the previous |
| | video frame, and wherein the method further comprises: |
| | estimating a current feature parameter set for the current video frame from |
| | the current latent SV representation using a contextual decoder that includes one or |
| | more convolutional layers; |
| | reconstructing the current video frame from the estimated current feature |
| | parameter set; and |
| | outputting the reconstructed current video frame. |
| A10 | The method of A6, wherein the current latent representation is a current latent |
| | motion vector (“MV”) representation for the current video frame, wherein the |
| | previous latent representation is a previous latent MV representation for the previous |
| | video frame, and wherein the method further comprises determining MV values for |
| | the current video frame from the current latent MV representation using an MV |
| | contextual decoder that includes one or more convolutional layers. |
| A11 | The method of any one of A1-A10, wherein the estimating the statistical |
| | characteristics of the quantized version of the current latent representation is also |
| | based at least in part on hyper prior parameters for the current video frame, the hyper |
| | prior parameters having been generated from the current latent representation using |
| | a hyper prior encoder that includes one or more convolutional layers. |
| A12 | The method of any one of A1-A4 and A6-A9, wherein the estimating the statistical |
| | characteristics of the quantized version of the current latent representation is also |
| | based at least in part on one or more temporal context parameter sets for the current |
| | video frame, the one or more temporal context parameter sets having been generated |
| | from a previous feature parameter set for the previous video frame and motion |
| | vector (“MV”) values for the current video frame using a temporal context mining |
| | network that includes one or more convolutional layers. |
| A13 | The method of any of A1-A10, wherein the statistical characteristics include one or |
| | more mean values and one or more scale parameters for a probability distribution |
| | function for the quantized version of the current latent representation. |
| A14 | The method of any one of A1-A13, wherein elements of the current latent |
| | representation are logically organized along a channel dimension and two spatial |
| | dimensions. |
| A15 | The method of A14, wherein the estimating the statistical characteristics of the |
| | quantized version of the current latent representation includes: |
| | splitting the elements of the current latent representation into multiple sets of |
| | elements in different channel sets along the channel dimension and different spatial |
| | position sets along the two spatial dimensions, each of the multiple sets of elements |
| | having a different combination of one of the different channel sets and one of the |
| | different spatial position sets; and |
| | based at least in part on a quantized version of a first set of elements among |
| | the multiple sets of elements, estimating the statistical characteristics of a quantized |
| | version of a second set of elements among the multiple sets of elements. |
| A16 | The method of A15, wherein the multiple sets of elements include: |
| | the first set of elements, the first set of elements having elements in a first |
| | channel set among the different channel sets and in a first spatial position set among |
| | the different spatial position sets; |
| | the second set of elements, the second set of elements having elements in the |
| | first channel set and in a second spatial position set among the different spatial |
| | position sets; |
| | a third set of elements, the third set of elements having elements in a second |
| | channel set among the different channel sets and in the second spatial position set; |
| | and |
| | a fourth set of elements, the fourth set of elements having elements in the |
| | second channel set and in the first spatial position set. |
| A17 | The method of A16, wherein the estimating the statistical characteristics of the |
| | quantized version of the current latent representation includes: |
| | estimating statistical characteristics of the quantized version of the first set of |
| | elements; |
| | estimating statistical characteristics of a quantized version of the third set of |
| | elements; |
| | fusing the quantized version of the first set of elements and the quantized |
| | version of the third set of elements with other inputs; and |
| | estimating statistical characteristics of a quantized version of the fourth set of |
| | elements using results of the fusing; |
| | wherein the estimating the statistical characteristics of the quantized version |
| | of the second set of elements also uses results of the fusing. |
| A18 | The method of A1, further comprising: |
| | quantizing the current latent representation in multiple stages using different |
| | quantization step (“QS”) values in the multiple stages, respectively, thereby |
| | producing the quantized version of the current latent representation. |
| A19 | The method of A6, further comprising: |
| | inverse quantizing the quantized version of the current latent representation |
| | in multiple stages using different quantization step (“QS”) values in the multiple |
| | stages, respectively. |
| A20 | The method of A18 or A19, wherein the different QS values include: |
| | a global QS value for regulating bit rate and overall quality; |
| | multiple per-channel QS values for different channels of the current latent |
| | representation; and |
| | multiple per-area QS values for different spatial areas of the current latent |
| | representation, the different spatial areas being associated with different positions or |
| | regions of the current latent representation, and the different per-area QS values |
| | being channel-specific or channel-independent. |
| A21 | One or more non-transitory computer-readable media storing computer-executable |
| | instructions for causing a computer system, when programmed thereby, to perform |
| | operations of the method of any one of A1 to A20. |
| A22 | A computer system configured to perform operations of the method of any one of |
| | A1-A5 and A11-A20, the computer system comprising: |
| | a frame buffer configured to store the current frame or current video frame; |
| | a video encoder configured to perform the encoding; and |
| | a coded data buffer configured to store the encoded data for output. |
| A23 | A computer system configured to perform operations of the method of any one of |
| | A6-A20, the computer system comprising: |
| | a coded data buffer configured to store the encoded data; |
| | a video decoder configured to perform the decoding; and |
| | a frame buffer configured to store the reconstructed current video frame for |
| | output. |

B. Entropy Model with Cross-channel, Cross-area Estimation

| | |
|---|---|
| B1 | In a computer system that implements a neural image encoder or neural video |
| | encoder, a method comprising: |
| | receiving a current frame; |
| | encoding the current frame to produce encoded data, wherein encoding the |
| | current frame comprises: |
| | determining a current latent representation for the current frame, |
| | wherein elements of the current latent representation are logically organized |
| | along a channel dimension and two spatial dimensions; and |
| | encoding the current latent representation using an entropy model |
| | network that includes one or more convolutional layers, wherein the |
| | encoding the current latent representation using the entropy model network |
| | comprises: |
| | splitting the elements of the current latent representation into |
| | multiple sets of elements in different channel sets along the channel |
| | dimension and different spatial position sets along the two spatial |
| | dimensions, each of the multiple sets of elements having a different |
| | combination of one of the different channel sets and one of the |
| | different spatial position sets; |
| | estimating statistical characteristics of quantized versions of |
| | the multiple sets of elements, respectively, including, based at least in |
| | part on the quantized version of a first set of elements among the |
| | multiple sets of elements, estimating the statistical characteristics of |
| | the quantized version of a second set of elements among the multiple |
| | sets of elements; and |
| | entropy coding the quantized versions of the multiple sets of |
| | elements, respectively, based at least in part on the estimated |
| | statistical characteristics; and |
| | outputting the encoded data as part of a bitstream. |
| B2 | The method of B1, further comprising: |
| | quantizing the current latent representation, thereby producing the quantized |
| | versions of the multiple sets of elements for the current latent representation. |
| B3 | The method of B2, wherein the encoding the current latent representation using the |
| | entropy model network further comprises: |
| | determining at least some quantization step (QS) values for the current latent |
| | representation, wherein the quantizing uses the at least some QS values. |
| B4 | The method of B1, wherein the current latent representation is a current latent |
| | sample value (“SV”) representation for the current frame, and wherein the |
| | determining the current latent representation comprises determining the current |
| | latent SV representation using a contextual encoder that includes one or more |
| | convolutional layers. |
| B5 | The method of B1, wherein the current latent representation is a current latent |
| | motion vector (“MV”) representation for the current frame, and wherein the |
| | determining the current latent representation comprises: |
| | using motion estimation to determine MV values for the current frame |
| | relative to a previous frame; and |
| | determining the current latent MV representation from the MV values using |
| | an MV contextual encoder that includes one or more convolutional layers. |
| B6 | In a computer system that implements a neural image decoder or neural video |
| | decoder, a method comprising: |
| | receiving encoded data as part of a bitstream; and |
| | decoding the encoded data to reconstruct a current frame, wherein the |
| | decoding the encoded data comprises: |
| | reconstructing a current latent representation for the current frame |
| | using an entropy model network that includes one or more convolutional |
| | layers, wherein elements of the current latent representation are logically |
| | organized along a channel dimension and two spatial dimensions, the |
| | elements of the current latent representation having been split into multiple |
| | sets of elements in different channel sets along the channel dimension and |
| | different spatial position sets along the two spatial dimensions, each of the |
| | multiple sets of elements having a different combination of one of the |
| | different channel sets and one of the different spatial position sets, and |
| | wherein the reconstructing the current latent representation comprises: |
| | estimating statistical characteristics of quantized versions of |
| | the multiple sets of elements, respectively, including, based at least in |
| | part on the quantized version of a first set of elements among the |
| | multiple sets of elements, estimating statistical characteristics of the |
| | quantized version of a second set of elements among the multiple sets |
| | of elements; and |
| | entropy decoding the quantized versions of the multiple sets |
| | of elements, respectively, based at least in part on the estimated |
| | statistical characteristics. |
| B7 | The method of B6, further comprising: |
| | inverse quantizing the quantized versions of the multiple sets of elements for |
| | the current latent representation. |
| B8 | The method of B7, wherein the reconstructing the current latent representation using |
| | the entropy model network further comprises |
| | determining at least some quantization step (QS) values for the current latent |
| | representation, wherein the inverse quantizing uses the at least some QS values. |
| B9 | The method of B6, wherein the current latent representation is a current latent |
| | sample value (“SV”) representation for the current frame, and wherein the method |
| | further comprises: |
| | estimating a current feature parameter set for the current frame from the |
| | current latent SV representation using a contextual decoder that includes one or |
| | more convolutional layers; |
| | reconstructing the current frame from the estimated current feature parameter |
| | set; and |
| | outputting the reconstructed current frame. |
| B10 | The method of B6, wherein the current latent representation is a current latent |
| | motion vector (“MV”) representation for the current frame, and wherein the method |
| | further comprises determining MV values for the current frame from the current |
| | latent MV representation using an MV contextual decoder that includes one or more |
| | convolutional layers. |
| B11 | The method of any of B1-B10, wherein the statistical characteristics include one or |
| | more mean values and one or more scale parameters for a probability distribution |
| | function for each of the quantized versions of the multiple sets of elements, |
| | respectively. |
| B12 | The method of any one of B1-B10, wherein the multiple sets of elements include: |
| | the first set of elements, the first set of elements having elements in a first |
| | channel set among the different channel sets and in a first spatial position set among |
| | the different spatial position sets; |
| | the second set of elements, the second set of elements having elements in the |
| | first channel set and in a second spatial position set among the different spatial |
| | position sets; |
| | a third set of elements, the third set of elements having elements in a second |
| | channel set among the different channel sets and in the second spatial position set; |
| | and |
| | a fourth set of elements, the fourth set of elements having elements in the |
| | second channel set and in the first spatial position set. |
| B13 | The method of B12, wherein the estimating the statistical characteristics of the |
| | quantized versions of the multiple sets of elements, respectively, includes: |
| | estimating the statistical characteristics of the quantized version of the first |
| | set of elements; |
| | estimating the statistical characteristics of the quantized version of the third |
| | set of elements; |
| | fusing the quantized version of the first set of elements and the quantized |
| | version of the third set of elements with other inputs; and |
| | estimating the statistical characteristics of the quantized version of the fourth |
| | set of elements using results of the fusing; |
| | wherein the estimating the statistical characteristics of the quantized version |
| | of the second set of elements also uses results of the fusing. |
| B14 | The method of B12, wherein: |
| | the first channel set includes a first half of channels; |
| | the second channel set includes a second half of channels; |
| | the first spatial position set includes one of even positions and odd positions; |
| | and |
| | the second spatial position set includes the other of the even positions and the |
| | odd positions. |
| B15 | The method of B12, wherein the entropy model network includes: |
| | a first fusion stage that fuses inputs; |
| | a first estimation stage that, using output from the first fusion stage, estimates |
| | the statistical characteristics of the quantized version of the first set of elements and |
| | the statistical characteristics of the quantized version of the third set of elements; |
| | a second fusion stage that fuses the quantized version of the first set of |
| | elements and the quantized version of the third set of elements with other inputs, |
| | wherein the other inputs include some output from the first estimation stage; and |
| | a second estimation stage that, using output from the second fusion stage, |
| | estimates the statistical characteristics of the quantized version of the second set of |
| | elements and the statistical characteristics of the quantized version of the fourth set |
| | of elements. |
| B16 | The method of any one of B1-B10, wherein the estimating the statistical |
| | characteristics of the quantized versions of the multiple sets of elements is also |
| | based at least in part on: |
| | hyper prior parameters for the current frame, the hyper prior parameters |
| | having been generated from the current latent representation using a hyper prior |
| | encoder that includes one or more convolutional layers; and |
| | if the current frame is a current video frame, a previous latent representation |
| | for a previous video frame. |
| B17 | The method of any one of B1-B4 and B6-B9, wherein the estimating the statistical |
| | characteristics of the quantized versions of the multiple sets of elements is also |
| | based at least in part on: |
| | hyper prior parameters for the current frame, the hyper prior parameters |
| | having been generated from the current latent representation using a hyper prior |
| | encoder that includes one or more convolutional layers; and |
| | if the current frame is a current video frame: |
| | a previous latent representation for a previous video frame; and |
| | one or more temporal context parameter sets for the current video |
| | frame, the one or more temporal context parameter sets having been |
| | generated from a previous feature parameter set for the previous video frame |
| | and motion vector (“MV”) values for the current video frame using a |
| | temporal context mining network that includes one or more convolutional |
| | layers. |
| B18 | The method of B1, further comprising: |
| | quantizing the current latent representation in multiple stages using different |
| | quantization step (“QS”) values in the multiple stages, respectively, thereby |
| | producing the quantized version of the current latent representation. |
| B19 | The method of B6, further comprising: |
| | inverse quantizing the quantized versions of the current latent representation |
| | in multiple stages using different quantization step (“QS”) values in the multiple |
| | stages, respectively. |
| B20 | The method of B18 or B19, wherein the different QS values include: |
| | a global QS value for regulating bit rate and overall quality; |
| | multiple per-channel QS values for different channels of the current latent |
| | representation; and |
| | multiple per-area QS values for different spatial areas of the current latent |
| | representation, the different spatial areas being associated with different positions or |
| | regions of the current latent representation, and the different per-area QS values |
| | being channel-specific or channel-independent. |
| B21 | One or more non-transitory computer-readable media storing computer-executable |
| | instructions for causing a computer system, when programmed thereby, to perform |
| | operations of the method of any one of B1 to B20. |
| B22 | A computer system configured to perform operations of the method of any one of |
| | B1-B5 and B11-B20, the computer system comprising: |
| | a frame buffer configured to store the current frame or current video frame; |
| | a video encoder configured to perform the encoding; and |
| | a coded data buffer configured to store the encoded data for output. |
| B23 | A computer system configured to perform operations of the method of any one of |
| | B6-B20, the computer system comprising: |
| | a coded data buffer configured to store the encoded data; |
| | a video decoder configured to perform the decoding; and |
| | a frame buffer configured to store the reconstructed current video frame for |
| | output. |

C. Entropy Model Network Supporting Multi-Granularity Quantization

| | |
|---|---|
| C1 | In a computer system that implements a neural image encoder or neural video |
| | encoder, a method comprising: |
| | receiving a current frame; |
| | encoding the current frame to produce encoded data, wherein encoding the |
| | current frame comprises: |
| | determining a current latent representation for the current frame, |
| | wherein elements of the current latent representation are logically organized |
| | along a channel dimension and two spatial dimensions; |
| | quantizing the current latent representation in multiple stages using |
| | different quantization step (“QS”) values in the multiple stages, respectively, |
| | thereby producing a quantized version of the current latent representation; |
| | and |
| | entropy coding the quantized version of the current latent |
| | representation; and |
| | outputting the encoded data as part of a bitstream. |
| C2 | The method of C1, wherein the encoding the current frame further comprises: |
| | estimating statistical characteristics of the quantized version of the current |
| | latent representation using an entropy model network that includes one or more |
| | convolutional layers, wherein the entropy coding is based at least in part on the |
| | estimated statistical characteristics. |
| C3 | The method of C2, wherein the encoding the current frame further comprises: |
| | using the entropy model network to determine at least some of the QS values. |
| C4 | The method of C1, wherein the current latent representation is a current latent |
| | sample value (“SV”) representation for the current frame, and wherein the |
| | determining the current latent representation comprises determining the current |
| | latent SV representation using a contextual encoder that includes one or more |
| | convolutional layers. |
| C5 | The method of C1, wherein the current latent representation is a current latent |
| | motion vector (“MV”) representation for the current frame, and wherein the |
| | determining the current latent representation comprises: |
| | using motion estimation to determine MV values for the current frame |
| | relative to a previous frame; and |
| | determining the current latent MV representation from the MV values using |
| | an MV contextual encoder that includes one or more convolutional layers. |
| C6 | In a computer system that implements an image decoder or a video decoder, a |
| | method comprising: |
| | receiving encoded data as part of a bitstream; |
| | decoding the encoded data to reconstruct a current frame, wherein decoding |
| | the encoded data comprises: |
| | reconstructing a current latent representation for the current frame, |
| | wherein elements of the current latent representation are logically organized |
| | along a channel dimension and two spatial dimensions, wherein the |
| | reconstructing the current latent representation comprises: |
| | entropy decoding a quantized version of the current latent |
| | representation; and |
| | inverse quantizing the quantized version of the current latent |
| | representation in multiple stages using different quantization step |
| | (“QS”) values in the multiple stages, respectively. |
| C7 | The method of C6, wherein the decoding the current frame further comprises: |
| | estimating statistical characteristics of the quantized version of the current |
| | latent representation using an entropy model network that includes one or more |
| | convolutional layers, wherein the entropy decoding is based at least in part on the |
| | estimated statistical characteristics. |
| C8 | The method of C7, wherein the decoding the current frame further comprises: |
| | using the entropy model network to determine at least some of the QS values. |
| C9 | The method of C6, wherein the current latent representation is a current latent |
| | sample value (“SV”) representation for the current frame, and wherein the method |
| | further comprises: |
| | estimating a current feature parameter set for the current frame from the |
| | current latent SV representation using a contextual decoder that includes one or |
| | more convolutional layers; |
| | reconstructing the current frame from the estimated current feature parameter |
| | set; and |
| | outputting the reconstructed current frame. |
| C10 | The method of C6, wherein the current latent representation is a current latent |
| | motion vector (“MV”) representation for the current frame, and wherein the method |
| | further comprises determining MV values for the current frame from the current |
| | latent MV representation using an MV contextual decoder that includes one or more |
| | convolutional layers. |
| C11 | The method of any one of C1-C10, wherein the different QS values include: |
| | a global QS value for regulating bit rate and overall quality; |
| | multiple per-channel QS values for different channels of the current latent |
| | representation; and |
| | multiple per-area QS values for different spatial areas of the current latent |
| | representation, the different spatial areas being associated with different positions or |
| | regions of the current latent representation, and the different per-area QS values |
| | being channel-specific or channel-independent. |
| C12 | The method of any one of C1-C5, wherein the multiple stages include: |
| | a first stage that includes using a global QS value, among the different QS |
| | values, to quantize respective elements of the current latent representation; |
| | a second stage that includes using multiple per-channel QS values, among |
| | the different QS values, to quantize the respective elements of the current latent |
| | representation in different channels; and |
| | a third stage that includes using per-area QS values, among the different QS |
| | values, to quantize the respective elements of the current representation in different |
| | spatial areas for the different channels. |
| C13 | The method of any one of C6-C10, wherein the multiple stages include: |
| | a first stage that includes using per-area QS values, among the different QS |
| | values, to inverse quantize respective elements of the current representation in |
| | different spatial areas for different channels; |
| | a second stage that includes using multiple per-channel QS values, among |
| | the different QS values, to inverse quantize the respective elements of the current |
| | latent representation in the different channels; and |
| | a third stage that includes using a global QS value, among the different QS |
| | values, to inverse quantize the respective elements of the current latent |
| | representation. |
| C14 | The method of any one of C1-C10, wherein the different QS values include a global |
| | QS value, and wherein the encoded data includes one or more syntax elements that |
| | indicate the global QS value, the global QS value being permitted to vary within a |
| | range. |
| C15 | The method of any one of C1-C10, wherein the different QS values include multiple |
| | per-channel QS values, and wherein: |
| | the multiple per-channel QS values are pre-defined; or |
| | the encoded data includes syntax elements that indicate the multiple per- |
| | channel QS values. |
| C16 | The method of any one of C1-C10, further comprising estimating statistical |
| | characteristics of the quantized version of the current latent representation based at |
| | least in part on: |
| | hyper prior parameters for the current frame, the hyper prior parameters |
| | having been generated from the current latent representation using a hyper prior |
| | encoder that includes one or more convolutional layers; and |
| | if the current frame is a current video frame, a previous latent representation |
| | for a previous video frame. |
| C17 | The method of any one of C1-C4 and C6-C9, further comprising estimating |
| | statistical characteristics of the quantized version of the current latent representation |
| | based at least in part on: |
| | hyper prior parameters for the current frame, the hyper prior parameters |
| | having been generated from the current latent representation using a hyper prior |
| | encoder that includes one or more convolutional layers; and |
| | if the current frame is a current video frame: |
| | a previous latent representation for a previous video frame; and |
| | one or more temporal context parameter sets for the current video |
| | frame, the one or more temporal context parameter sets having been |
| | generated from a previous feature parameter set for the previous video frame |
| | and motion vector (“MV”) values for the current video frame using a |
| | temporal context mining network that includes one or more convolutional |
| | layers. |
| C18 | The method of any one of C1-C10, further comprising estimating statistical |
| | characteristics of the quantized version of the current latent representation, |
| | including: |
| | splitting the elements of the current latent representation into multiple sets of |
| | elements in different channel sets along the channel dimension and different spatial |
| | position sets along the two spatial dimensions, each of the multiple sets of elements |
| | having a different combination of one of the different channel sets and one of the |
| | different spatial position sets; and |
| | based at least in part on a quantized version of a first set of elements among |
| | the multiple sets of elements, estimating the statistical characteristics of a quantized |
| | version of a second set of elements among the multiple sets of elements. |
| C19 | The method of C18, wherein the multiple sets of elements include: |
| | the first set of elements, the first set of elements having elements in a first |
| | channel set among the different channel sets and in a first spatial position set among |
| | the different spatial position sets; |
| | the second set of elements, the second set of elements having elements in the |
| | first channel set and in a second spatial position set among the different spatial |
| | position sets; |
| | a third set of elements, the third set of elements having elements in a second |
| | channel set among the different channel sets and in the second spatial position set; |
| | and |
| | a fourth set of elements, the fourth set of elements having elements in the |
| | second channel set and in the first spatial position set. |
| C20 | The method of C19, wherein the estimating the statistical characteristics of the |
| | quantized version of the current latent representation includes: |
| | estimating statistical characteristics of the quantized version of the first set of |
| | elements; |
| | estimating statistical characteristics of a quantized version of the third set of |
| | elements; |
| | fusing the quantized version of the first set of elements and the quantized |
| | version of the third set of elements with other inputs; and |
| | estimating statistical characteristics of a quantized version of the fourth set of |
| | elements using results of the fusing; |
| | wherein the estimating the statistical characteristics of the quantized version |
| | of the second set of elements also uses results of the fusing. |
| C21 | One or more non-transitory computer-readable media storing computer-executable |
| | instructions for causing a computer system, when programmed thereby, to perform |
| | operations of the method of any one of C1 to C20. |
| C22 | A computer system configured to perform operations of the method of any one of |
| | C1-C5 and C11-C20, the computer system comprising: |
| | a frame buffer configured to store the current frame or current video frame; |
| | a video encoder configured to perform the encoding; and |
| | a coded data buffer configured to store the encoded data for output. |
| C23 | A computer system configured to perform operations of the method of any one of |
| | C6-C20, the computer system comprising: |
| | a coded data buffer configured to store the encoded data; |
| | a video decoder configured to perform the decoding; and |
| | a frame buffer configured to store the reconstructed current video frame for |
| | output. |

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. In a computer system that implements a neural video encoder, a method comprising:
receiving a current video frame;
encoding the current video frame to produce encoded data, wherein the encoding the current video frame comprises:
determining a current latent representation for the current video frame; and
encoding the current latent representation using an entropy model network that includes one or more convolutional layers, wherein the encoding the current latent representation using the entropy model network comprises:
estimating statistical characteristics of a quantized version of the current latent representation based at least in part on a previous latent representation for a previous video frame; and
entropy coding the quantized version of the current latent representation based at least in part on the estimated statistical characteristics; and
outputting the encoded data as part of a bitstream.

2. The method of claim 1, further comprising:
quantizing the current latent representation, thereby producing the quantized version of the current latent representation.

3. The method of claim 2, wherein the encoding the current latent representation using the entropy model network further comprises:
determining at least some quantization step (QS) (“QS”) values for the current latent representation based at least in part on the previous latent representation, wherein the quantizing uses the at least some QS values.

4. The method of claim 1, wherein the current latent representation is a current latent sample value (“SV”) representation for the current video frame, wherein the previous latent representation is a previous latent SV representation for the previous video frame, and wherein the determining the current latent representation comprises determining the current latent SV representation using a contextual encoder that includes one or more convolutional layers.

5. The method of claim 1, wherein the current latent representation is a current latent motion vector (“MV”) representation for the current video frame, wherein the previous latent representation is a previous latent MV representation for the previous video frame, and wherein the determining the current latent representation comprises:
using motion estimation to determine MV values for the current video frame relative to the previous video frame; and
determining the current latent MV representation from the MV values using a MV contextual encoder that includes one or more convolutional layers.

6. In a computer system that implements a neural video decoder, a method comprising:
receiving encoded data as part of a bitstream; and
decoding the encoded data to reconstruct a current video frame, wherein the decoding the encoded data comprises:
reconstructing a current latent representation for the current video frame using an entropy model network that includes one or more convolutional layers, wherein the reconstructing the current latent representation comprises:
estimating statistical characteristics of a quantized version of the current latent representation based at least in part on a previous latent representation for a previous video frame; and
entropy decoding the quantized version of the current latent representation based at least in part on the estimated statistical characteristics.

7. The method of claim 6, further comprising:
inverse quantizing the quantized version of the current latent representation.

8. The method of claim 7, wherein the reconstructing the current latent representation using the entropy model network further comprises:
determining at least some quantization step (QS) (“QS”) values for the current latent representation based at least in part on the previous latent representation, wherein the inverse quantizing uses the at least some QS values.

9. The method of claim 6, wherein the current latent representation is a current latent sample value (“SV”) representation for the current video frame, wherein the previous latent representation is a previous latent SV representation for the previous video frame, and wherein the method further comprises:
estimating a current feature parameter set for the current video frame from the current latent SV representation using a contextual decoder that includes one or more convolutional layers;
reconstructing the current video frame from the estimated current feature parameter set; and
outputting the reconstructed current video frame.

10. The method of claim 6, wherein the current latent representation is a current latent motion vector (“MV”) representation for the current video frame, wherein the previous latent representation is a previous latent MV representation for the previous video frame, and wherein the method further comprises determining MV values for the current video frame from the current latent MV representation using a MV contextual decoder that includes one or more convolutional layers.

11. The method of claim 6, wherein the estimating the statistical characteristics of the quantized version of the current latent representation is also based at least in part on hyper prior parameters for the current video frame, the hyper prior parameters having been generated from the current latent representation using a hyper prior encoder that includes one or more convolutional layers.

12. The method of claim 6, wherein the estimating the statistical characteristics of the quantized version of the current latent representation is also based at least in part on one or more temporal context parameter sets for the current video frame, the one or more temporal context parameter sets having been generated from a previous feature parameter set for the previous video frame and motion vector (“MV”) values for the current video frame using a temporal context mining network that includes one or more convolutional layers.

13. The method of claim 6, wherein the statistical characteristics include one or more mean values and one or more scale parameters for a probability distribution function for the quantized version of the current latent representation.

14. The method of claim 6, wherein elements of the current latent representation are logically organized along a channel dimension and two spatial dimensions.

15. The method of claim 14, wherein the estimating the statistical characteristics of the quantized version of the current latent representation includes:
splitting the elements of the current latent representation into multiple sets of elements in different channel sets along the channel dimension and different spatial position sets along the two spatial dimensions, each of the multiple sets of elements having a different combination of one of the different channel sets and one of the different spatial position sets; and
based at least in part on a quantized version of a first set of elements among the multiple sets of elements, estimating the statistical characteristics of a quantized version of a second set of elements among the multiple sets of elements.

16. The method of claim 15, wherein the multiple sets of elements include:
the first set of elements, the first set of elements having elements in a first channel set among the different channel sets and in a first spatial position set among the different spatial position sets;
the second set of elements, the second set of elements having elements in the first channel set and in a second spatial position set among the different spatial position sets;
a third set of elements, the third set of elements having elements in a second channel set among the different channel sets and in the second spatial position set; and
a fourth set of elements, the fourth set of elements having elements in the second channel set and in the first spatial position set.

17. The method of claim 16, wherein the estimating the statistical characteristics of the quantized version of the current latent representation includes:
estimating statistical characteristics of the quantized version of the first set of elements;
estimating statistical characteristics of a quantized version of the third set of elements;
fusing the quantized version of the first set of elements and the quantized version of the third set of elements with other inputs; and
estimating statistical characteristics of a quantized version of the fourth set of elements using results of the fusing;
wherein the estimating the statistical characteristics of the quantized version of the second set of elements also uses results of the fusing.

18. (canceled)

19. The method of claim 6, further comprising:
inverse quantizing the quantized version of the current latent representation in multiple stages using different quantization step (“QS”) values in the multiple stages, respectively.

20. The method of claim 18 or 19, wherein the different QS values include:
a global QS value for regulating bit rate and overall quality;
multiple per-channel QS values for different channels of the current latent representation; and
multiple per-area QS values for different spatial areas of the current latent representation, the different spatial areas being associated with different positions or regions of the current latent representation, and the different per-area QS values being channel-specific or channel-independent.

21.-63. (canceled)

64. A computer system configured comprising:
a coded data buffer configured to store encoded data as part of a bitstream;
a neural video decoder configured to perform operations to decode the encoded data to reconstruct a current video frame, wherein the operations to decode the encoded data comprise reconstructing a current latent representation for the current video frame using an entropy model network that includes one or more convolutional layers, wherein the reconstructing the current latent representation comprises:
estimating statistical characteristics of a quantized version of the current latent representation based at least in part on a previous latent representation for a previous video frame; and
entropy decoding the quantized version of the current latent representation based at least in part on the estimated statistical characteristics; and
a frame buffer configured to store the reconstructed current video frame for output.
